(19) United States
(12) Patent Application Publication
(10) Pub. No.: US 2011/0236545 A1
(43) Pub. Date: Sep. 29, 2011

(54) Non-Dairy Creamers Comprising Protein Hydrolysate Compositions and Method for Producing the Non-Dairy Creamers

(75) Inventors: John A. Brown, Festus, MO (US); Theodore M. Wong, Ballwin, MO (US); Daniel U. Staerk, Kirkwood, MO (US); Carl Rose, Chesterfiled, MO (US); Saraia Ivy, Swansea, IL (US); David M. McKeague, St. Louis, MO (US); Zebin Wang, Fenton, MO (US)

(73) Assignee: SOLAE, LLC, St. Louis, MO (US)

(21) Appl. No.: 13/129,208

(22) PCT Filed: Dec. 3, 2009
(86) PCT No.: PCT/US09/66657

§ 371 Date: May 13, 2011

Related U.S. Application Data
(60) Provisional application No. 61/119,589, filed on Dec. 3, 2008.

(51) Int. Cl. A23C 11/06; A23J 3/00; A23J 3/04; A23J 3/14; A23J 3/16; A23J 3/18

(52) U.S. Cl. 426/330; 426/656; 426/657

(57) ABSTRACT

The present invention provides soy based non-dairy compositions and the method for producing the soy based non-dairy compositions. In particular, the soy based non-dairy compositions comprise soy protein hydrolysate compositions in non-dairy coffee creamers.

### FIELD OF THE INVENTION

The present invention generally provides non-dairy creamer compositions comprising an edible material and a protein hydrolysate composition, and optionally may include dairy proteins and the method for producing the non-dairy creamers.

### BACKGROUND OF THE INVENTION

Creamers are typically enjoyed as additives in coffee or other beverages. Dairy-based creamers are typically made with whole milk, butterfat, and/or heavy cream all containing lactose, while non-dairy creamers typically contain sodium caseinate, which is a milk protein derivative that does not contain lactose. While many may enjoy creamers, these condiments tend to be avoided for a variety of reasons. First, creamers are not nutritious products due to the high levels of fat and calories they typically contain. Second, a large portion of the population is not able to consume dairy-based creamers since they cannot metabolize lactose, a sugar found in dairy products. Third, some people choose not to eat dairy-based creamers due to religious or personal beliefs surrounding the consumption of dairy products. In light of all these factors, there is a need for a low-dairy or non-dairy creamer product.

Dairy-based creamers are desired because of the milky flavor and creamy texture. One product that is routinely used to replace dairy in a variety of products is soy protein. It is well known that there are non-dairy products containing soy currently available on the market. These products have reduced or eliminated the dairy content and may be nutritionally sound. Current soy proteins used on the market as an ingredient in non-dairy products tend to cause the product to have a “green:” or “beany” flavor that individuals find objectionable or unpalatable. Despite the emergence of these “healthy” substitute dairy options, it seems clear that consumers are not willing to sacrifice taste and texture in an effort to be healthy or avoid dairy. Therefore, a need exists for non-dairy or low-dairy creamers which strive to address health or belief restrictions by containing a soy protein product, but which still retain the tastes and textures people have come to know and love.

### SUMMARY OF THE INVENTION

One aspect of the present invention provides non-dairy creamer compositions comprising a protein hydrolysate having a mixture of protein and polypeptide fragments. These products optionally include dairy proteins. Additionally, the protein hydrolysate composition has a degree of hydrolysis of at least about 0.2%.

Other aspects and features of the invention are described in more detail below.

### DESCRIPTION OF THE FIGURES

FIG. 1 illustrates the interfacial tension (a measure of tension or energy at the interface of the oil phase and water phase reported in milliNewtons per meter (mN/m) as measured using the Tensiometer (PAT 1, Sinterface Technologies, Germany) of various proteins that may be included as ingredients for a soy-based non-dairy creamer. The proteins include sodium caseinate, (NaCaS); SUPRO® 120, soy protein material; SUPRO® 950, soy protein hydrolysate; SPP-A soy protein hydrolysate, TL1 soy protein hydrolysates treated with a protease (Novozymes, Denmark) both at 3.2% degree of hydrolysis (DH) (TL1-A and TL1-B); SUPRO® 670, soy protein hydrolysate; and SUPRO® 500E, soy protein material.

FIG. 2 illustrates the interfacial tension of TL1 hydrolyzed soy protein material having a DH of 3.2% (TL1-A) alone and in combination with various emulsifiers. The emulsifiers are sodium stearoyl-2-lactylate, (SSL); di-acetyl tartaric acid ester of monoglyceride, (DATEM); a common mixed-monoglyceride emulsifier (Dimodan® Danisco, Denmark); and polysorbate-60, (PS60).

FIG. 3 shows the interfacial tension of soy protein hydrolysates, SUPRO® 950 and SPP-A alone and in combination with various emulsifiers. The emulsifiers are SSL; DATEM; Dimodan®; and PS60.

FIG. 4 graphically illustrates the degree of “whiteness” (L-value) as measured using the HunterLab LabScan XE Sensor and Software (HunterLab, Reston, Va.) of liquid UHT non-dairy creamers containing various protein materials measured on the liquid creamer (bar containing dots) and the liquid creamer combined with prepared coffee (bar with diagonal lines). The HunterLab L,-value is a measure of lightness on a scale from 0 to 100, black to white respectively. When the degree of “whiteness” of the liquid creamer is measured, it is about three (3) times greater than when the liquid creamer is combined with brewed coffee. Therefore, the L-values for the liquid creamer were divided by three (3) in order to show up on the graph. The L-values for the liquid creamer in brewed coffee were used as measured. The proteins are sodium caseinate (NaCaS); SUPRO® 120 soy protein material, SUPRO® 950 and SPP-A soy protein hydrolysates; TL1 hydrolysate having a DH of 3.2%; and SUPRO® 670 soy protein hydrolysate.

FIG. 5 graphically illustrates the oil off (bar with dots) and feathering (bar with diagonal lines) characteristics of liquid UHT processed non-dairy creamers produced to compare functional capabilities of a variety of enzymatically treated soy protein materials. The proteins are sodium caseinate, (NaCaS); SUPRO® 120, soy protein material control; SUPRO® 950 and SPP-A, soy protein hydrolysates; TL1 soy protein hydrolysate (TL1-A); and SUPRO® 670, soy protein hydrolysate.

FIG. 6 graphically illustrates the sensory profiling of liquid coffee creamer flavor and texture differences based on Sodium Caseinate, soy protein hydrolysates (SUPRO® 950 and TL1-A), and combinations of Sodium Caseinate and soy proteins in liquid non-dairy coffee creamer. The black dashed line marks the Recognition Threshold Level.

FIG. 7 illustrates the flavor and texture sensory differences between the Sodium Caseinate, and soy protein materials (SUPRO® 120, SUPRO® 950, and TL1-A) in liquid non-dairy coffee creamer. The black dashed line marks the Recognition Threshold Level.

FIG. 8 illustrates the flavor and texture sensory differences between Sodium Caseinate alone and in combination with soy protein materials (SUPRO® 120, SUPRO® 950, and TL1-A) in liquid non-dairy coffee creamer. The black dashed line marks the Recognition Threshold Level.

FIG. 9 illustrates the flavor and texture sensory differences between Sodium Caseinate, SUPRO® 950 soy protein hydrolysate, and the combination of Sodium Caseinate and TL1-A soy protein hydrolysate in liquid non-dairy coffee creamer. The black dashed line marks the Recognition Threshold Level.

FIG. 10 graphically illustrates the sensory profiling of spray dried non-dairy coffee creamer flavor differences based on Sodium Caseinate, soy protein materials (SUPRO® 120, SUPRO® 950, and TL1-A), and combinations of Sodium Caseinate and the soy protein materials in brewed coffee. The black dashed line marks the Recognition Threshold Level.

FIG. 11 shows the sensory profiling of texture differences of spray dried non-dairy creamers based on Sodium Caseinate, soy protein materials (SUPRO® 120, SUPRO® 950, and TL1-A), and combinations of Sodium Caseinate and the soy protein materials in brewed coffee. The black dashed line marks the Recognition Threshold Level.

FIG. 12 illustrates the flavor and texture sensory differences of spray dried non-dairy creamers based on Sodium Caseinate, soy protein materials (SUPRO® 120, SUPRO® 950, and TL1-A), and combinations of Sodium Caseinate and the soy protein materials in brewed coffee. The black dashed line marks the Recognition Threshold Level.

FIG. 13 shows the flavor and texture sensory differences of spray dried non-dairy creamers between Sodium Caseinate and the 50:50 blends of SUPRO® 120:Caseinate, SUPRO® 950:Caseinate, and TL1-A:Caseinate in brewed coffee. The black dashed line marks the Recognition Threshold Level.

FIG. 14 shows the differences of spray dried non-dairy creamer between Sodium Caseinate, 100% SUPRO® 950, soy protein hydrolysate, and 50:50 TL1-A:Caseinate in brewed coffee. The black dashed line marks the Recognition Threshold Level.

FIG. 15 summarizes consumer acceptance ratings for spray dried non-dairy creamers prepared with Sodium Caseinate and soy protein materials (SUPRO® 120, SUPRO® 950, and TL1-A) in brewed coffee.

FIG. 16 graphically illustrates a summary of the consumer, acceptability scores of spray dried non-dairy coffee creamers based on Sodium Caseinate and combinations of Sodium Caseinate and soy protein materials (SUPRO® 120, SUPRO® 950, and TL1-A) in brewed coffee.

FIG. 17 graphically illustrates the sensory profiling of agglomerated spray dried non-dairy coffee creamer flavor differences based on Sodium Caseinate, soy protein hydrolysates (SPP-A (flavor system 1), SPP-A (flavor system 2), and TL1-A), and combinations of Sodium Caseinate and the soy protein hydrolysates in brewed coffee. Flavor system 1 is a soy masking flavor from Givaudan SA (France) and flavor system 2 is a dairy flavor system from Edlong Dairy Flavors (Elk Grove, Ill.). The black dashed line marks the Recognition Threshold Level.

FIG. 18 shows the sensory profiling of texture differences of agglomerated spray dried non-dairy creamers based on Sodium Caseinate, soy protein hydrolysates (SPP-A and TL1-A), and combinations of Sodium Caseinate and soy protein hydrolysates in brewed coffee. The black dashed line marks the Recognition Threshold Level.

FIG. 19 illustrates the flavor and texture sensory differences of agglomerated spray dried non-dairy creamers based on Sodium Caseinate, soy protein hydrolysates (SPP-A and TL1-A) in brewed coffee. The black dashed line marks the Recognition Threshold Level.

FIG. 20 shows the flavor and texture sensory differences of agglomerated spray dried non-dairy creamers between Sodium Caseinate and the 50:50 blends of SPP-A:Caseinate, TL1-A:Caseinate, and TL1-A:SPP-A:Caseinate in brewed coffee. The black dashed line marks the Recognition Threshold Level.

FIG. 21 graphically illustrates a summary of the consumer acceptability scores of agglomerated spray dried non-dairy coffee creamers based on Sodium Caseinate and soy protein hydrolysates (SPP-A (flavor system 1), SPP-A (flavor system 2), and TL1-A) in brewed coffee.

FIG. 22 graphically illustrates a summary of the consumer acceptability scores of agglomerated spray dried non-dairy coffee creamers based on Sodium Caseinate and combinations of Sodium Caseinate and soy protein hydrolysates (SPP-A and TL1-A) in brewed coffee.

### DETAILED DESCRIPTION OF THE INVENTION

The present invention provides non-dairy creamer products comprising a protein hydrolysate composition and processes for producing the non-dairy creamer products. The protein hydrolysate composition used in the non-dairy creamer products is comprised of a mixture of protein and polypeptide fragments. The non-dairy creamer products of the invention optionally include dairy proteins in addition to the protein hydrolysate composition. Advantageously, as illustrated in the examples, the non-dairy creamer compositions of the invention, which contain a protein hydrolysate composition described herein, possess improved flavor, texture, mouth feel, and aroma as compared to non-dairy creamer products containing different soy proteins.

(I) Non-Dairy Creamer Compositions

One aspect of the invention provides non-dairy creamer (NDC) compositions comprising a mixture of dairy proteins and protein hydrolysate compositions at various ratios. Another aspect of the invention provides NDC compositions comprising only protein hydrolysate compositions and no dairy proteins. The composition and properties of the protein hydrolysates are detailed below in section (I) A. The NDC compositions of the invention that include various ratios of a protein hydrolysate composition generally have improved flavor and texture characteristics as compared to NDCs comprised of other soy proteins, using NDCs containing one hundred percent dairy as a benchmark.

A. Protein Hydrolysate Compositions

The protein hydrolysate compositions, compared with the protein starting material will comprise a mixture of protein and polypeptide fragments of varying length and molecular weights. The protein and polypeptide fragments may range in size from about 75 Daltons (Da) to about 50,000 Da, or more preferably from about 150 Da to about 20,000 Da. In some embodiments, the average molecular size of the protein and polypeptide fragments may be less than about 20,000 Da. In other embodiments, the average molecular size of the protein and polypeptide fragments may be less than about 15,000 Da. In still other embodiment, the average molecular size of the protein and polypeptide fragments may be less than about 10,000 Da. In additional embodiments, the average molecular size of the protein and polypeptide fragments may be less than about 5000 Da.

The degree of hydrolysis of the protein hydrolysate compositions of the invention can and will vary depending upon the source of the protein material, the endopeptidase used, and the degree of completion of the hydrolysis reaction. The degree of hydrolysis (DH) refers to the percentage of peptide bonds cleaved versus the starting number of peptide bonds. For example, if a starting protein containing five hundred peptide bonds is hydrolyzed until fifty of the peptide bonds are cleaved, then the DH of the resulting hydrolysate is 10%. The degree of hydrolysis may be determined using the simplified trinitrobenzene sulfonic acid (STNBS) colorimetric method or the ortho-phthaldialdehyde (OPA) method, as commonly known in the art. The higher the degree of hydrolysis the greater the extent of protein hydrolysis. Typically, as the protein is further hydrolyzed (i.e., the higher the DH), the molecular weight of the peptide fragments decreases, the peptide profile changes accordingly, and the viscosity of the mixture decreases. The DH may be measured in the entire hydrolysate (i.e., whole fraction) or the DH may be measured in the soluble fraction of the hydrolysate (e.g., the supernatant fraction after centrifugation of the hydrolysate at about 500-1500×g for about 5-20 min).

In general, the degree of hydrolysis of the protein hydrolysate will be at least about 0.2%. In one embodiment, the degree of hydrolysis of the protein hydrolysate may range from about 0.2% to about 2%. In another embodiment, the degree of hydrolysis of the protein hydrolysate may range from about 2% to about 8%. In yet another embodiment, the degree of hydrolysis of the protein hydrolysate may range from about 8% to about 14%. In an alternate embodiment, the degree of hydrolysis of the protein hydrolysate may range from about 14% to about 20%. In additional embodiments, the degree of hydrolysis of the protein hydrolysate may be greater than about 20%.

The solubility of the protein hydrolysate compositions can and will vary depending upon the source of the starting protein material, the endopeptidase used, and the pH of the composition. The soluble solids index (SSI) is a measure of the solubility of the solids (i.e., protein and polypeptide fragments) comprising a protein hydrolysate composition. The amount of soluble solids may be estimated by measuring the amount of solids in solution before and after centrifugation (e.g., about 500-1500×g for about 5-20 min). Alternatively, the amount of soluble solids may be determined by estimating the amount of protein in the composition before and after centrifugation using techniques well known in the art (e.g., a bicinchoninic acid (BCA) protein determination colorimetric assay).

In general, the protein hydrolysate composition of the invention, regardless of its degree of hydrolysis, has a soluble solids index of at least about 80% at a pH greater than about pH 6.0. In one embodiment, the protein hydrolysate composition may have a soluble solids index ranging from about 80% to about 85% at a pH greater than about pH 6.0. In another embodiment, the protein hydrolysate composition may have a soluble solids index ranging from about 85% to about 90% at a pH greater than about pH 6.0. In a further embodiment, the protein hydrolysate composition may have a soluble solids index ranging from about 90% to about 95% at a pH greater than about 6.0. In another alternate embodiment, the protein hydrolysate composition may have a soluble solids index ranging from about 95% to about 99% at a pH greater than about 6.0.

Furthermore, the solubility of the protein hydrolysate compositions of the invention may vary between about pH 4.0 to about pH 5.0 as a function of the degree of hydrolysis. For example, soy protein hydrolysate compositions having degrees of hydrolysis greater than about 3% tend to be more soluble between about pH 4.0 to about pH 5.0 than those having degrees of hydrolysis less than about 3%.

Generally speaking, soy protein hydrolysate compositions having degrees of hydrolysis of about 1% to about 6% are stable at a pH between about pH 7.0 to about pH 8.0. Stability refers to the lack of sediment formation over time. The protein hydrolysate compositions may be stored at room temperature (i.e., about 21° C. (70° F.)) or a refrigerated temperature (i.e., about 4° C. (40° F.)). In one embodiment, the protein hydrolysate composition may be stable for about one week to about four weeks. In another embodiment, the protein hydrolysate composition may be stable for about one month to about six months. In a further embodiment, the protein hydrolysate composition may be stable for more than about six months.

The protein hydrolysate composition may be dried. For example, the protein hydrolysate composition may be spray dried. The temperature of the spray dryer inlet may range from about 204° C. (400° F.) to about 315° C. (600° F.) and the exhaust temperature may range from about 82° C. (180° F.) to about 100° C. (212° F.). Alternatively, the protein hydrolysate composition may be vacuum dried, freeze dried, or dried using other procedures known in the art.

In embodiments in which the protein hydrolysate is derived from soy protein, the degree of hydrolysis may range from about 0.2% to about 14%, and more preferably from about 1% to about 6%. In addition to the number of protein and polypeptide fragments formed, as illustrated in the examples, the degree of hydrolysis typically impacts other physical properties and sensory properties of the resulting soy protein hydrolysate composition. Typically, as the degree of hydrolysis increases from about 1% to about 6%, the soy protein hydrolysate composition has increased transparency or translucency and decreased grain and soy/legume sensory attributes. Furthermore, the soy protein hydrolysate composition has substantially less bitter sensory attributes when the degree of hydrolysis is less than about 2% compared to when the degree of hydrolysis is greater than about 2%. Stated another way, higher degrees of hydrolysis reduce grain and soy/legume sensory attributes, whereas lower degrees of hydrolysis reduce bitter sensory attributes. The sensory attributes and methods for determining them are detailed in the Examples.

It is also envisioned that the protein hydrolysate compositions of the invention may further comprise a non-hydrolyzed (i.e., intact) protein. The non-hydrolyzed protein may be present in an essentially intact preparation (such as, e.g., soy curd, corn meal, milk, etc.) Furthermore, the non-hydrolyzed protein may be isolated from a plant-derived protein source (e.g., sources such as amaranth, arrowroot, barley, buckwheat, canola, cassava, channa (garbanzo), legumes, lentils, lupin, maize, millet, oat, pea, potato, rice, rye, sorghum, sunflower, tapioca, triticale, wheat, and so forth) or isolated from an animal protein material (examples of suitable isolated animal proteins include acid casein, caseinate, whey, albumin, gelatin, and the like). In preferred embodiments, the protein hydrolysate composition further comprises a non-hydrolyzed protein selected from the group consisting of barley, canola, lupin, maize, oat, pea, potato, rice, soy, wheat, animal, dairy, egg, and combinations thereof. The relative proportions of the protein hydrolysate and the non-hydrolyzed protein can and will vary depending upon the proteins involved and the desired use of the composition.

B. Process for Preparing a Protein Hydrolysate

The process for preparing a protein hydrolysate comprising a mixture of protein and polypeptide fragments that have primarily either an arginine residue or a lysine residue at each carboxyl terminus comprises contacting a protein material with an endopeptidase that specifically cleaves the peptide bonds of the protein material on the carboxyl terminal side of an arginine residue or a lysine residue to produce a protein hydrolysate. The protein material or combination of protein materials used to prepare a protein hydrolysate can and will vary. Examples of suitable protein material are detailed below.

(a) Soy Protein Material

In some embodiments, the protein material may be a soy protein material. A variety of soy protein materials may be used in the process of the invention to generate a protein hydrolysate. In general, the soy protein material may be derived from whole soybeans in accordance with methods known in the art. The whole soybeans may be standard soybeans (i.e., non genetically modified soybeans), genetically modified soybeans (such as, e.g., soybeans with modified oils, soybeans with modified carbohydrates, soybeans with modified protein subunits, and so forth) or combinations thereof. Suitable examples of soy protein material include soy extract, soymilk, soymilk powder, soy curd, soy flour, soy protein isolate, soy protein concentrate, and mixtures thereof.

In one embodiment, the soy protein material used in the process may be a soy protein isolate (also called isolated soy protein, or ISP). In general, soy protein isolates have a protein content of at least about 90% soy protein on a moisture-free basis. The soy protein isolate may comprise intact soy proteins or it may comprise partially hydrolyzed soy proteins. The soy protein isolate may have a high content of storage protein subunits such as 7S, 11S, 2S, etc. Non-limiting examples of soy protein isolates that may be used as starting material in the present invention are commercially available, for example, from Solae, LLC (St. Louis, Mo.), and among them include SUPRO® 500E, SUPRO® 545, SUPRO® 620, SUPRO® 670, SUPRO® EX 33, SUPRO® 950, SUPRO® PLUS 2600F, SUPRO® PLUS 2640DS, SUPRO® PLUS 2800, SUPRO® PLUS 3000, and combinations thereof.

In one embodiment TL1, a microbial subtilisin protease available from Novozymes (Bagsvaerd, Denmark), was used to make hydrolyzed proteins so that the sensory and functionality of the proteins could be compared. A slurry of 8% isolated soy protein was prepared by blending 72 g of SUPRO® 500E in 828 g of tap water using moderate mixing for 5 min. Two drops of defoamer were added. The pH of the slurry was adjusted to 8.0 with 2 N KOH. Aliquots (800 g) of the slurry were heated to 50° C. with mixing. Varying amounts of TL1 peptidase protease were added to achieve varying degrees of hydrolysis. An autotitrator was used to keep the pH of the reaction constant at pH 8.0. After incubating at 50° C. for a period of time, the samples were heated to 85° C. for 5 min to inactivate the enzymes, and the solutions were adjusted to pH 7.0. The samples were chilled on ice and stored at 4° C. The DH of each protein sample was determined using the TNBS method.

In another embodiment, the soy protein material may be a soy protein concentrate, which has a protein content of about 65% to less than about 90% on a moisture-free basis. Examples of suitable soy protein concentrates useful in the invention include the PROCON™ product line, ALPHA® 12 and ALPHA® 5800, all of which are commercially available from Solae, LLC. Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 40% of the soy protein isolate by weight, at most, and more preferably is substituted for up to about 30% of the soy protein isolate by weight.

In yet another embodiment, the soy protein material may be soy flour, which has a protein content of about 49% to about 65% on a moisture-free basis. The soy flour may be defatted soy flour, partially defatted soy flour, or full fat soy flour. The soy flour may be blended with soy protein isolate or soy protein concentrate.

In an alternate embodiment, the soy protein material may be material that has been separated into four major storage protein fractions or subunits (15S, 11S, 7S, and 2S) on the basis of sedimentation in a centrifuge. In general, the 11S fraction is highly enriched in glycinins, and the 7S fraction is highly enriched in beta-conglycinins. In still yet another embodiment, the soy protein material may be protein from high oleic soybeans.

(b) Other Protein Materials

In another embodiment, the protein material may be derived from a plant other than soy. By way of non-limiting example, suitable plants include amaranth, arrowroot, barley, buckwheat, canola, cassava, channa (garbanzo), legumes, lentils, lupin, maize, millet, oat, pea, potato, rice, rye, sorghum, sunflower, tapioca, triticale, wheat, and mixtures thereof. Especially preferred plant proteins include barley, canola, lupin, maize, oat, pea, potato, rice, wheat, and combinations thereof. In one embodiment, the plant protein material may be canola meal, canola protein isolate, canola protein concentrate, or combinations thereof. In another embodiment, the plant protein material may be maize or corn protein powder, maize or corn protein concentrate, maize or corn protein isolate, maize or corn germ, maize or corn gluten, maize or corn gluten meal, maize or corn flour, zein protein, or combinations thereof. In still another embodiment, the plant protein material may be barley powder, barley protein concentrate, barley protein isolate, barley meal, barley flour, or combinations thereof. In an alternate embodiment, the plant protein material may be lupin flour, lupin protein isolate, lupin protein concentrate, or combinations thereof. In another alternate embodiment, the plant protein material may be oatmeal, oat flour, oat protein flour, oat protein isolate, oat protein concentrate, or combinations thereof. In yet another embodiment, the plant protein material may be pea flour, pea protein isolate, pea protein concentrate, or combinations thereof. In still another embodiment, the plant protein material may be potato protein powder, potato protein isolate, potato protein concentrate, potato flour, or combinations thereof. In a further embodiment, the plant protein material may be rice flour, rice meal, rice protein powder, rice protein isolate, rice protein concentrate, or combinations thereof. In another alternate embodiment, the plant protein material may be wheat protein powder, wheat gluten, wheat germ, wheat flour, wheat protein isolate, wheat protein concentrate, solubilized wheat proteins, or combinations thereof.

In other embodiments, the protein material may be derived from an animal source. In one embodiment, the animal protein material may be derived from eggs. Non-limiting examples of suitable egg proteins include powdered egg, dried egg solids, dried egg white protein, liquid egg white protein, egg white protein powder, isolated ovalbumin protein, and combinations thereof. Egg proteins may be derived from the eggs of chicken, duck, goose, quail, or other birds. In an alternate embodiment, the protein material may be derived from a dairy source. Suitable dairy proteins include non-fat dry milk powder, milk protein isolate, milk protein concentrate, acid casein, caseinate (e.g., sodium caseinate, calcium caseinate, and the like), whey protein isolate, whey protein concentrate, and combinations thereof. The milk protein material may be derived from cows, goats, sheep, donkeys, camels, camelids, yaks, water buffalos, etc. In a further embodiment, the protein may be derived from the muscles, organs, connective tissues, or skeletons of land-based or aquatic animals. As an example, the animal protein may be gelatin, which is produced by partial hydrolysis of collagen extracted from the bones, connective tissues, organs, etc, from cattle or other animals.

It is also envisioned that combinations of a soy protein material and at least one other protein material also may be used in the process of the invention. That is, a protein hydrolysate composition may be prepared from a combination of a soy protein material and at least one other protein material. In one embodiment, a protein hydrolysate composition may be prepared from a combination of a soy protein material and one other protein material selected from the group consisting of barley, canola, lupin, maize, oat, pea, potato, rice, wheat, animal material, dairy, and egg. In another embodiment, a protein hydrolysate composition may be prepared from a combination of a soy protein material and two other protein materials selected from the group consisting of barley, canola, lupin, maize, oat, pea, potato, rice, wheat, animal material, dairy, and egg. In further embodiments, a protein hydrolysate composition may be prepared from a combination of a soy protein material and three or more other protein materials selected from the group consisting of barley, canola, lupin, maize, oat, pea, potato, rice, wheat, animal material, dairy, and egg.

The concentrations of the soy protein material and the other protein material used in combination can and will vary. The amount of soy protein material may range from about 1% to about 99% of the total protein used in the combination. In one embodiment, the amount of soy protein material may range from about 1% to about 20% of the total protein used in combination. In another embodiment, the amount of soy protein material may range from about 20% to about 40% of the total protein used in combination. In still another embodiment, the amount of soy protein material may range from about 40% to about 80% of the total protein used in combination. In a further embodiment, the amount of soy protein material may range from about 80% to about 99% of the total protein used in combination. Likewise, the amount of the (at least one) other protein material may range from about 1% to about 99% of the total protein used in combination. In one embodiment, the amount of other protein material may range from about 1% to about 20% of the total protein used in combination. In another embodiment, the amount of other protein material may range from about 20% to about 40% of the total protein used in combination. In still another embodiment, the amount of other protein material may range from about 40% to about 80% of the total protein used in combination. In a further embodiment, the amount of other protein material may range from about 80% to about 99% of the total protein used in combination.

(c) Protein Slurry

In the process of the invention, the protein material is typically mixed or dispersed in water to form a slurry comprising about 1% to about 20% protein by weight (on an “as is” basis). In one embodiment, the slurry may comprise about 1% to about 5% protein (as is) by weight. In another embodiment, the slurry may comprise about 6% to about 10% protein (as is) by weight. In a further embodiment, the slurry may comprise about 11% to about 15% protein (as is) by weight. In still another embodiment, the slurry may comprise about 16% to about 20% protein (as is) by weight.

After the protein material is dispersed in water, the slurry of protein material may be heated from about 70° C. to about 90° C. for about 2 minutes to about 20 minutes to inactivate putative endogenous protease inhibitors. Typically, the pH and the temperature of the protein slurry are adjusted so as to optimize the hydrolysis reaction, and in particular, to ensure that the endopeptidase used in the hydrolysis reaction functions near its optimal activity level. The pH of the protein slurry may be adjusted and monitored according to methods generally known in the art. The pH of the protein slurry may be adjusted and maintained at from about pH 5.0 to about pH 10.0. In one embodiment, the pH of the protein slurry may be adjusted and maintained at from about pH 7.0 to about pH 8.0. In another embodiment, the pH of the protein slurry may be adjusted and maintained at from about pH 8.0 to about pH 9.0. In a preferred embodiment, the pH of the protein slurry may be adjusted and maintained at about pH 8.0. The temperature of the protein slurry is preferably adjusted and maintained at from about 40° C. to about 70° C. during the hydrolysis reaction in accordance with methods known in the art. In a preferred embodiment, the temperature of the protein slurry may be adjusted and maintained at from about 50° C. to about 60° C. during the hydrolysis reaction. In general, temperatures above this range may eventually inactivate the endopeptidase, while temperatures below or above this range tend to slow the activity of the endopeptidase.

(d) Endopeptidase

The hydrolysis reaction is generally initiated by adding an endopeptidase to the slurry of protein material. Several endopeptidases are suitable for use in the process of the invention. Preferably, the endopeptidase will be a food-grade enzyme. The endopeptidase may have optimal activity under the conditions of hydrolysis from about pH 6.0 to about pH 11.0, and more preferably, from about pH 7.0 to about pH 9.0, and at a temperature from about 40° C. to about 70° C., and more preferably from about 45° C. to about 60° C.

In general, the endopeptidase may be a member of the S1 serine protease family (MEROPS Peptidase Database, release 8.00A; //merops.sanger.ac.uk). Preferably, the endopeptidase will cleave peptide bonds on the carboxyl terminal side of arginine, lysine, or both residues. Thus, endopeptidase may be a trypsin-like endopeptidase, which cleaves peptide bonds on the carboxyl terminal side of arginine, lysine, or both. A trypsin-like endopeptidase in the context of the present invention may be defined as an endopeptidase having a Trypsin ratio of more than 100. The trypsin-like endopeptidase may be a lysyl endopeptidase, which cleaves peptide bonds on the carboxyl terminal side of lysine residues. In preferred embodiments, the endopeptidase may be of microbial origin, and more preferably of fungal origin.

Additional suitable peptidases include, but are not limited to, those of the serine endopeptidase family isolated from Bacillus subtilis. Representative alkaline proteases suitable for use in the processes of the present invention may include Alcalase® (Novozymes, Denmark); Alkaline Protease Concentrate (Valley Research, South Bend, Ind.); and Protex 6 L (Danisco, Palo Alto, Calif.). Preferably, the endopeptidase known as Alcalase® may be used to produce highly hydrolyzed soy protein polypeptides with a DH between about 0.1% to about 15%.

The amount of endopeptidase added to the protein material can and will vary depending upon the source of the protein material, the desired degree of hydrolysis, and the duration of the hydrolysis reaction. The amount of endopeptidase may range from about 1 mg of enzyme protein to about 5000 mg of enzyme protein per kilogram of protein material. In another embodiment, the amount may range from 10 mg of enzyme protein to about 3000 mg of enzyme protein per kilogram of protein material. In yet another embodiment, the amount may range from about 50 mg of enzyme protein to about 1000 mg of enzyme protein per kilogram of protein material.

As will be appreciated by a skilled artisan, the duration of the hydrolysis reaction can and will vary. Generally speaking, the duration of the hydrolysis reaction may range from a few minutes to many hours, such as, from about 30 minutes to about 48 hours. To end the hydrolysis reaction, the composition may be heated to a temperature that is high enough to inactivate the endopeptidase. For example, heating the composition to a temperature of approximately 90° C. will substantially heat-inactivate the endopeptidase.

(II) Preparation of a Non-Dairy Creamer Containing a Protein Hydrolysate

The NDCs detailed in (I), above, are comprised of any of the protein hydrolysate compositions detailed in (I) A, and any edible material. Alternatively, the NDCs may comprise any of the protein hydrolysate compositions in lieu of dairy. Alternatively, the NDCs may comprise an edible material and any of the isolated protein and polypeptide fragments described herein.

### A. Inclusion of the Protein Hydrolysate Composition

The concentration of protein hydrolysate in the NDCs can and will vary depending on the product being made. In embodiments comprising a high percentage of dairy protein, the percentage of protein hydrolysate will be low. Whereas, in embodiments without added dairy protein, the percentage of protein hydrolysate in the various NDCs will be high. Thus, the concentration of the protein hydrolysate of the protein ingredient in the various NDCs may be less than about 1%, 2%, 5%, 10%, 15%, 20%, 25%, 30%, 35%, 40%, 45%, 50%, 60%, 65%, 70%, 75%, 80%, 85%, 90%, 95%, and 100% by weight.

The selection of a particular protein hydrolysate composition to combine with an edible material can and will vary depending upon the desired NDC product. In some embodiments, the protein hydrolysate composition may be derived from barley, canola, lupin, maize, oat, pea, potato, rice, wheat, animal, egg, or combinations thereof. In still other embodiments, the protein hydrolysate composition may be derived from a combination of soy and at least one other protein source selected from the group consisting of barley, canola, lupin, maize, oat, pea, potato, rice, wheat, animal, dairy, and egg. In alternative embodiments, the protein hydrolysate composition may comprise a combination of different protein hydrolysates.

The degree of hydrolysis of the protein hydrolysate composition will also vary depending upon the starting material used to make the hydrolysate and the desired NDC. For example, in certain embodiments where it may be desirable to minimize the bitter sensory attribute, a soy protein hydrolysate composition having a degree of hydrolysis closer to or less than 1% rather than 6% may be selected. Additionally, in alternative embodiments, when it may be desirable to minimize the grain and soy/legume sensory attributes in an NDC, a soy protein hydrolysate composition having a degree of hydrolysis closer to or greater than 6% rather than 1% may be selected.

B. Optional Blending with Dairy

The protein hydrolysate composition may optionally be blended with dairy. In some embodiments, the concentration of dairy may be about 95%, 90%, 80%, 70%, 60%, or 50% by weight, and the concentration of the protein hydrolysate may be about 5%, 10%, 20%, 30%, 40%, or 50% by weight. In other embodiments, the concentration of dairy may be about 40%, 30%, 20%, 10%, 5%, or 0% by weight, and the concentration of the protein hydrolysate may be about 60%, 70%, 80%, 90%, 95%, or 100% by weight. In one embodiment, the concentration of dairy may range from about 50% to about 95% by weight, and the concentration of the protein hydrolysate may range from about 5% to about 50% by weight. In another embodiment, the concentration of dairy may range from about 0% to about 50% by weight, and the concentration of the protein hydrolysate may range from about 50% to about 100% by weight.

### DEFINITIONS

To facilitate understanding of the invention, several terms are defined below.

The term “degree of hydrolysis” refers to the percentage of the total peptide bonds that are cleaved.

The term “endopeptidase” refers to an enzyme that hydrolyzes internal peptide bonds in oligopeptide or polypeptide chains. The group of endopeptidases comprises enzyme subclasses EC 3.4.21-25 (International Union of Biochemistry and Molecular Biology enzyme classification system).

A “food grade enzyme” is an enzyme that is generally recognized as safe (GRAS) approved and is safe when consumed by an organism, such as a human. Typically, the enzyme and the product from which the enzyme may be derived are produced in accordance with applicable legal and regulatory guidelines.

A “hydrolysate” is a reaction product obtained when a compound is cleaved through the effect of water. Protein hydrolysates occur subsequent to thermal, chemical, or enzymatic degradation. During the reaction, large molecules are broken into smaller proteins, soluble proteins, peptide fragments, and free amino acids.

The term “interfacial tension” as used herein is a measure of tension or energy at the interface of the oil phase and water phase reported in milliNewtons per meter (mN/m) as measured using the Tensiometer (PAT1, Sinterface Technologies, Germany). The method for measuring interfacial tension was as follows: a droplet with a surface area of 30 millimeters² (mm²) was formed at the end of a capillary tube from the aqueous phase (containing protein and other ingredients) and came into contact with the vegetable oil contained in a quartz container. The capillary tube is inserted into the vegetable oil prior to forming the droplet. The droplet is formed by pumping the desired amount of aqueous phase into the capillary tube is inserted into the oil. The shape of the droplet changed with time due the interfacial tension decreasing. Pictures of the droplet were taken every second in the oil. The pictures were analyzed and the interfacial tension at every second was calculated by the instrument software.

The term “sensory attribute,” such as used to describe characteristics like “grain,” “soy/legume,” or “bitter” is determined in accordance with the Descriptive Profiling System as specifically delineated in Example 2.

The terms “soy protein isolate” or “isolated soy protein,” as used herein, refer to a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted, partially defatted, or full fat soybean material having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and carbohydrates of the cotyledon.

The term “simplified trinitrobenzene sulfonic acid test” (hereinafter STNBS) as used to provide a measure of the degree of hydrolysis of soy proteins. Primary amines occur in soy proteins as amino terminal groups and also as the amino group of lysyl residues. The process of enzymatic hydrolysis cleaves the peptide chain structure of soy proteins creating one new amino terminal with each new break in the chain. Trinitrobenzene sulfonic acid (TNBS) reacts with these primary amines to produce a chromophore which absorbs light at 420 nm The intensity of color developed from a TNBS-amine reaction is proportional to the total number of amino terminal groups in a soy protein sample, and, therefore, is an indicator of the degree of hydrolysis of the protein in the sample.

Specifically, to determine the degree of hydrolysis of an isolated soy protein sample, 0.1 grams of the isolated soy protein is added to 100 milliliters 0.025N NaOH. The sample mixture is stirred for 10 minutes and is filtered through Whatman No. 4 filter paper. A 2-milliliter portion of the sample mixture is then diluted to 10 milliliters with 0.05M sodium borate buffer (pH 9.5). A 2-milliliter blank of 0.025N NaOH is also diluted to 10 milliliters with 0.05M sodium borate buffer (pH 9.5). Aliquots (2 milliliters) of the sample mixture and the blank (2 milliliters) are then placed in separate test tubes. Duplicate 2-milliliter samples of glycine standard solution (0.005M) are also placed in separate test tubes. Then, 0.3M TNBS (0.1-0.2 milliliters) is added to each test tube and the tubes are vortexed for 5 seconds. The TNBS is allowed to react with each proteinaceous sample, blank, and standard for 15 minutes. The reaction is terminated by adding 4 milliliters of phosphate-sulfite solution (1% 0.1M Na₂SO₃, 99% 0.1M NaH₂PO₄.H₂O) to each test tube with vortexing for 5 seconds. The absorbance of all samples, blanks, and standards are recorded against deionized water within 20 minutes of the addition of the phosphate-sulfite solution.
The STNBS value, which is a measure of NH₂ moles/10⁵ grams protein, is then calculated using the following formula:

STNBS=(As₄₂₀−Ab₄₂₀)×(8.073)×(1/W)×(F)(100/P)

wherein As₄₂₀ is the TNBS absorbance of the sample solution at 420 nm; Ab₄₂₀ is the TNBS absorbance of the blank at 420 nm; 8.073 is the extinction coefficient and dilution/unit conversion factor in the procedure; W is the weight of the isolated soy protein sample; F is a dilution factor; and P is the percent protein content of the sample, measured using the Kjeldahl, Kjel-Foss, or LECO combustion procedures.

The term “soluble solids index” (SSI) as used herein refers to the solubility of a soy protein material in an aqueous solution as measured according to the following formula:

$$SSI ( \% ) = ( \frac{Soluble Solids}{Total Solids} ) x 100.$$

Soluble Solids and Total Solids are determined as follows:
1. A sample of the protein material is obtained by accurately weighing out 12.5 g of protein material.
2. 487.5 g of deionized water is added to a quart blender jar.
3. 2 to 3 drops of defoamer (Dow Corning Antifoam B Emulsion, 1:1 dilution with water) is added to the deionized water in the blender jar.
4. The blender jar containing the water and defoamer is placed on a blender (Osterizer), and the blender stirring speed is adjusted to create a moderate vortex (about 14,000 rpm).
5. A timer is set for 90 seconds, and the protein sample is added to the water and defoamer over a period of 30 seconds while blending. Blending is continued for the remaining 60 seconds after addition of the protein sample (total blending time should be 90 seconds from the start of addition of the protein sample).
6. The resulting protein material sample/water/defoamer slurry is then transferred to a 500 ml beaker containing a magnetic stirring bar. The beaker is then covered with plastic wrap or aluminum foil.
7. The covered beaker containing the slurry is then placed on a stirring plate, and the slurry is stirred at moderate speed for a period of 30 minutes.
8. 200 g of the slurry is then transferred into a centrifuge tube. A second 200 g sample of the slurry is then transferred into a second centrifuge tube. The remaining portion of the slurry in the beaker is retained for measuring total solids.
9. The 2 centrifuge tube samples are then centrifuged at 500×g for 10 minutes (1500 rpm on an IEC Model K).
10. At least 50 ml of the supernatant is withdrawn from each centrifuge tube and placed in a plastic cup (one cup for each sample from each centrifuge tube, 2 total cups).
11. Soluble Solids is then determined by drying a 5 g sample of each supernatant at 130° C. for 2 hours, measuring the weights of the dried samples, and averaging the weights of the dried samples.
12. Total Solids is determined by drying two 5 g samples of the slurry retained in the beaker, measuring the weights of the dried samples, and averaging the weights of the dried samples.
13. The Soluble Solids Index (SSI) is calculated from the Soluble Solids and Total Solids according to the formula above.

A “trypsin-like protease” is an enzyme that preferentially cleaves a peptide bond on the carboxyl terminal side of an arginine residue or a lysine residue.

The color of a solution or material is measured using the HunterLab LabScan XE Sensor and Software Colorimeter, from which the L value specifically relates to lightness (a scale from black to white (ranging from zero to one hundred respectively) of the solution or material.

When referring to functional analysis of NDC in coffee the term “oil-off” is a common term used to describe the visual appearance of oil droplets or oily film appearing on surface of coffee. This is simply a visual observation and is generally reported as being either none, slight, medium or high. The oil droplets or oily film is evidence of the NDC emulsion breaking down under the conditions encountered by addition to hot acidic coffee.

When referring to functional analysis of NDC in coffee, the term “feathering” is a term used to describe the appearance of particulates or aggregates forming in the coffee that has the NDC dispersed in it. These particulates or aggregates are the result of protein contained in the NDC becoming insoluble in the conditions of acidity encounter in coffee. This is simply a visual observation and is generally reported by the industry as being either none, slight, medium or high.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above compounds, products and methods without departing from the scope of the invention, it is intended that all matter contained in the above description and in the examples given below, shall be interpreted as illustrative and not in a limiting sense.

### EXAMPLES

The following examples illustrate embodiments of the invention.

### Example 1

### Soy Protein Material has Similar Functionality to Sodium Caseinate

As an alternative to lactose-containing dairy-based products, sodium caseinate, a milk protein derivative, can be substituted for milk protein or dairy cream ingredients to provide a NDC product that is lactose free. To be a non-dairy product, soy protein material was determined to be an acceptable alternative to using sodium caseinate in non-dairy creamer.

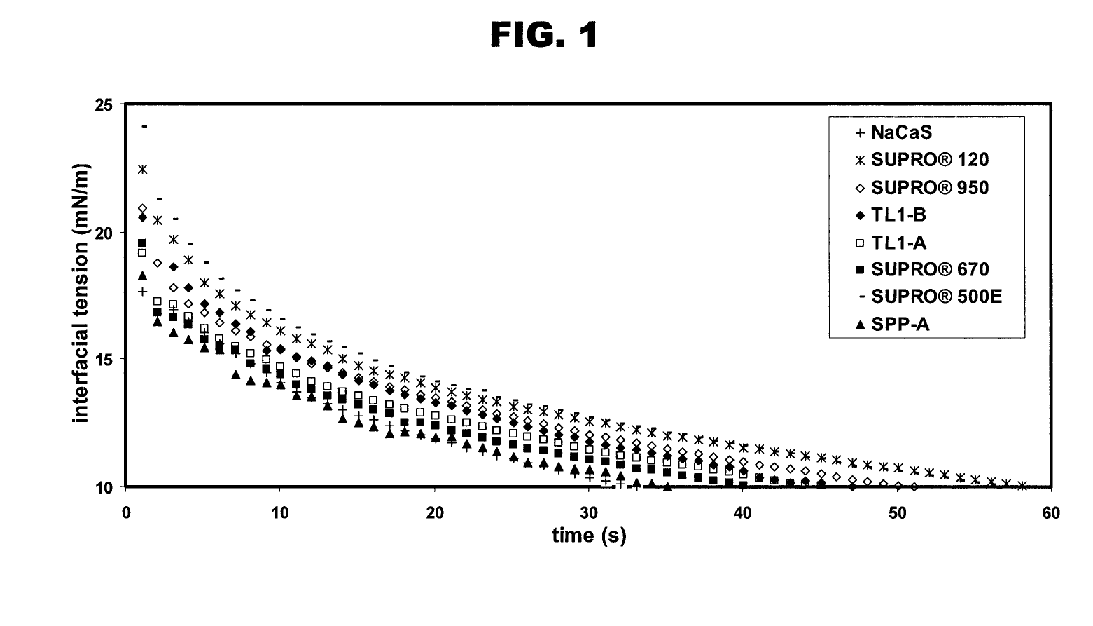

Ingredients commonly used as emulsifiers in non-dairy products were evaluated to set a standard by which to compare the functionality of soy protein material containing samples. The interfacial tension was measured for sodium caseinate and various soy protein material preparations (FIG. 1). Samples SUPRO® 670, TL1 Hydrolysate, and SPP-A were similar to the interfacial tension of sodium caseinate (FIG. 1). Of those samples, SUPRO® 670 was soy protein material enzymatically treated with Bromelain. Samples of TL1 Hydrolysate, and SPP-A were each soy protein material enzymatically treated at different dosing, resulting in different degrees of hydrolysis (DH).

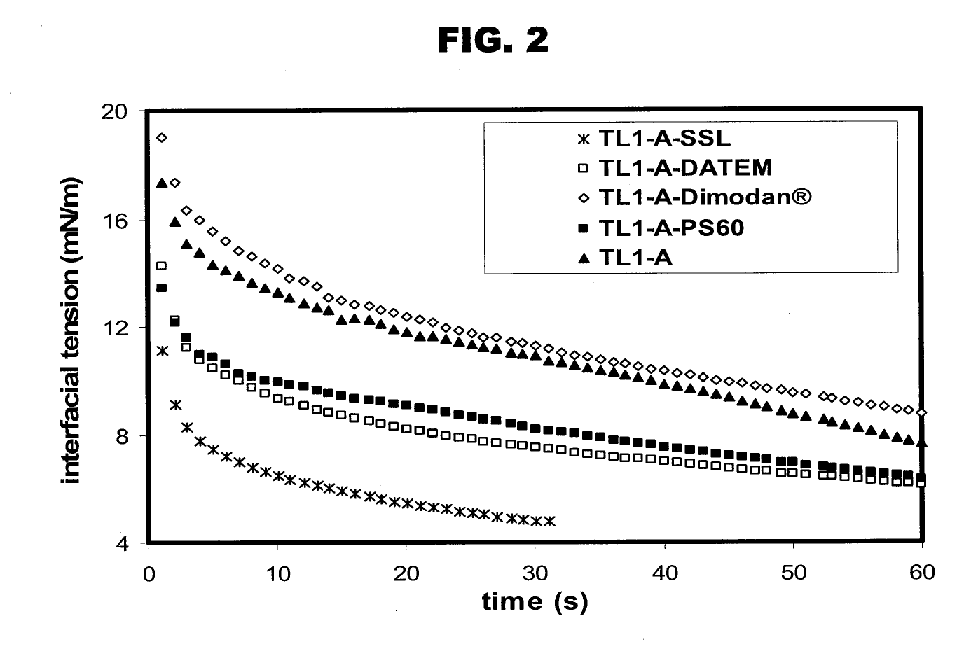

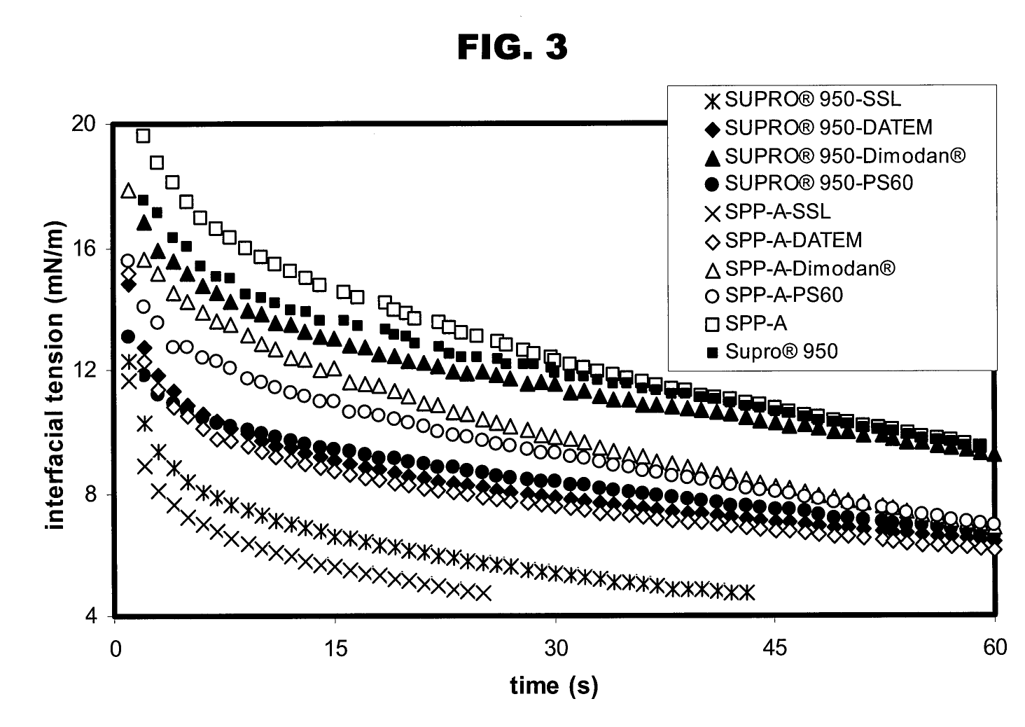

The interfacial tension was measured for various soy protein material preparations in combination with emulsifiers (FIGS. 2 and 3) for comparison. FIG. 2 shows the interfacial tension of TL1 soy protein hydrolysate at a DH of 3.2% in combination with emulsifiers including Danisco Grinsted® SSL, DATEM Panodan®, Dimodan®, and PS60. Further, FIG. 3 shows the interfacial tension of soy protein hydrolysates, SUPRO® 950 and SPP-A in combination with emulsifiers. Based on the interfacial tension comparisons, the samples containing SPP-A soy protein material in combination with SSL and DATEM were recommended for further analysis.

### Example 2

### Soy Protein as an Alternative to Sodium Caseinate in a Liquid UHT Processed Non-Dairy Creamer Model

To determine if soy protein could substitute for sodium caseinate in non-dairy creamers, the functionality of soy protein was compared to that of sodium caseinate while used in a liquid UHT non-dairy creamer. The non-dairy creamer model was based on Nestle Liquid Cofffeemate™, Original having the characteristics detailed in Table 1. The ingredients used to make the reference liquid non-dairy creamer are detailed in Table 2.

TABLE 1
Nestle UHT Liquid Original Coffeemate ™ Model Characteristics

| Component | Percentage by weight |
|---|---|
| Moisture | 74.55 to 78.95 |
| Carbohydrate | 10-12 |
| Total Fat | 10-12 |
| Emulsifiers | 0.3-0.5 |
| Protein | 0.5-0.6 |
| Phosphate buffer | 0.25-0.35 |

TABLE 2
Liquid UHT Non-Dairy Creamer Formula

| Ingredient | % as is |
|---|---|
| Water | 78.28 |
| Corn syrup solids, 25DE | 11.00 |
| Soybean Oil | 9.50 |
| Protein (Na caseinate or soy protein | 0.57 |
| hydrolysate SUPRO ® 120, SUPRO ® 950, | |
| SUPRO ® 670, TL1-A or SPP-A) | |
| Dipotassium phosphate | 0.35 |
| Sodium stearoyl-2-lactylate (SSL) | 0.15 |
| Polysorbate 60 (PS 60) | 0.15 |
| Total | 100.00 |

The liquid UHT non-dairy creamers are made by combining the ingredients listed in Table 2. Specifically, water and phosphate buffer are mixed and heated to 60° C. using a steam jacketed stainless steel process vessel equipped with an air operated propeller mixer. The protein is uniformly dispersed into the water/phosphate buffer mixture using moderate to high speed mixing, which is then heated to 77° C. and mixed at slow speed for 6 minutes to facilitate complete hydration. To this mixture the carbohydrates and SSL are added and then mixing continued for 5 minutes. A preblend of the soybean oil and PS60 is then added to the slurry and mixing continued for an additional for 5 minutes to complete the ingredient addition. The slurry is homogenized using a 3 piston, 2 stage NIRO Model 2006 homogenizer at 2500 psi total (500 psi, 2^{nd} stage/2000 psi, 1^{st} stage. The slurry was UHT heat treated at 142° C. for 4 to 6 seconds and then cooled to 31° C. bottled into pre-sterilized 250 ml Nalgene bottles, capped and stored at 4° C.

The liquid non-dairy creamer quality is evaluated using objective measurements of whiteness (L-value), viscosity and pH and subjective evaluations for oil separation, feathering (protein aggregation) both as is and in a prepared coffee solution. Each sample evaluated differed by the protein contained in the sample. The proteins consisted of the reference proteins sodium caseinate (NaCaS); SUPRO® 120, soy protein material not hydrolyzed; SUPRO® 950 and SPP-A soy protein hydrolysates; TL1 Hydrolysate, soy protein material at a DH of 3.2%; and SUPRO® 670, soy protein hydrolysate.

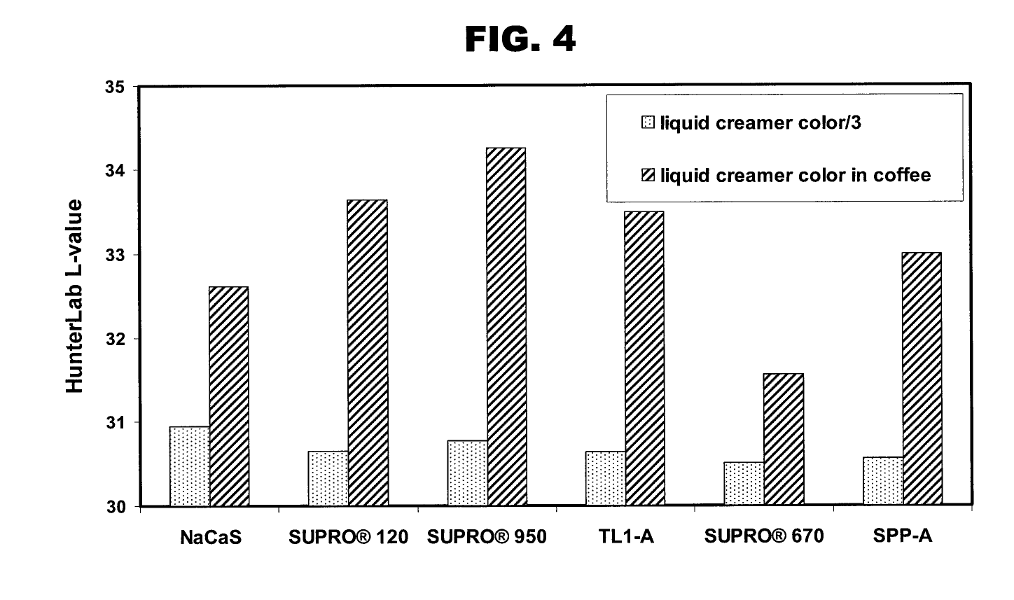

The lightness of the samples correlates to the particle size and emulsion characteristics of each creamer. The L-value measurement for the non-dairy creamers as well as the non-dairy creamers in prepared coffee are presented in FIG. 4. An L-value of 33 or higher is generally recognized as acceptable lightness produce by the mixture of non-dairy creamer in coffee. The results indicated that the enzymatic treatment of soy protein slightly affected the lightness characteristic in comparison to sodium caseinate. Specifically, Sodium Caseinate and SUPRO® 670 had overall lower and unacceptable L-values, while the remaining enzymatically treated soy protein samples and non-enzymatically treated soy protein exhibited an overall higher and acceptable L-value in coffee.

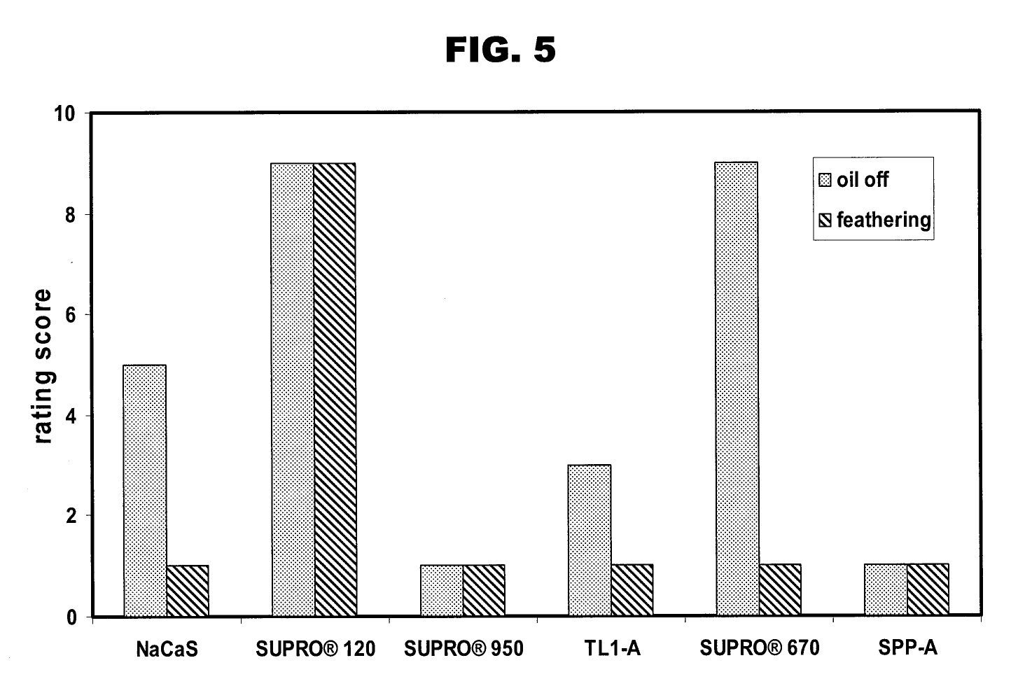

The feathering of the samples measured correlates to the flocculation or protein aggregation (instability) occurring when the non-dairy creamer is dispersed in prepared coffee, where the lower the number the less feathering. The feathering measurement is similar among the enzymatically treated soy protein material containing samples which is similar to sodium caseinate (FIG. 5). The non-enzymatically treated sample (SUPRO® 120 shows the greatest amount of feathering.

The “oil off” values (FIG. 5) of the liquid creamers correlates to the coalescence of oil (creaming) or emulsion stability of each creamer. SUPRO® 120, non-enzymatically treated soy protein material and SUPRO® 670, enzymatically treated soy material based creamers had greater oil off rates compared to that of sodium caseinate (FIG. 5). The remaining soy protein hydrolysates SUPRO® 950, TL1, and SPP-A had lower oil off values compared to that of sodium caseinate.

### Sensory Profiling of the Liquid Non-Dairy Coffee Creamers.

To understand the attribute differences among various soy protein preparations used in coffee creamers and their similarity to Sodium Caseinate, a sensory descriptive analysis was conducted. The sensory descriptive analysis compared Sodium Caseinate, 100% SUPRO® 120, 100% SUPRO® 950, 100% TL1-A, 50:50 SUPRO® 120:Caseinate, 50:50 SUPRO® 950:Caseinate, and 50:50 TL1-A:Caseinate.

Nine panelists trained in the Sensory Descriptive Profiling method evaluated the samples for 23 flavor and 9 texture attributes. The attributes were evaluated on a 15-point scale, with 0=none/not applicable and 15=very strong/high in each sample. Definitions of the flavor attributes are given in Table 3 and definitions of the texture attributes are given in Table 4.

The samples were prepared in liquid form by adding 667 grams of non-dairy coffee creamer powder blended into 1333 grams of distilled water. The samples were presented monadically in duplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attributes. See Tables 5 and 6.

TABLE 3
Lexicon for flavor attributes.

| AROMATICS | | | |
|---|---|---|---|
| Overall Flavor | The overall intensity of the product aromas, | | |
| Impact | an amalgamation of all perceived aromatics, | | |
| | basic tastes and chemical feeling factors. | | |
| Dark roasted | The aromatic associated with dark roasted | Dark roasted nuts, coffee | |
| | nutmeat and having a very browned or | grounds | |
| | toasted characteristic | | |
| Green Complex | The general category of aromatics associated | Green beans, tomato vines, | |
| | with green vegetation including stems, grass, | fresh cut grass | |
| | leaves and green herbs. | | |
| Grassy | The green, slightly sweet aromatic associated | Fresh cut grass, aroma of | |
| | with cut grass. | fresh green beans | |
| Viney | The vegetative, green-woody, earthy aromatic | Tomato vines | |
| | associated with plant vines such tomato vines. | | |
| Beany | The dirty green-woody aromatic associated | Fresh green beans | |
| | with cooked beans such as lima, navy, green, | | |
| | etc. | | |
| Sweet Aromatics | The general category of aromatics associated | | |
| | with sweet foods. | | |
| Caramelized | The aromatics associated with browned | Caramelized sugar | |
| | sugars such as caramel. | | |
| Vanilla/Vanillin | The aromatics associated with vanilla, | Vanilla Extract, Vanillin | |
| | including artificial vanilla, woody, and browned | crystals | |
| | notes. | | |
| Lactone | The sweet, tropical, nutty aromatic associated | Cocoa butter, imitation | |
| | with meat or milk from coconut. | coconut flavor | |
| Milky | The slightly sour, animal, milky aromatic | Skim Milk, NFDM | |
| | associated with skim milk and milk derived | | |
| | products. | | |
| Grain | The aromatics associated with the total grain | All-purpose flour paste, cream | |
| | impact, which may include all types of grain | of wheat, whole wheat pasta | |
| | and different stages of heating. May include | | |
| | wheat, whole wheat, oat, rice, graham, etc | | |
| Burnt | The progression of cooking attributes after | Burnt meat, burnt charcoal, | |
| | Browned/Roasted/Caramelized that may or | burnt grains | |
| | may not include charcoal and ash aromatics | (popcorn and toast) | |
| Soy/Legume | The earthy/dirty, green aromatics associated | Unsweetened Silk, Canned | |
| | with legumes/soybeans; may include all types | Soybeans, Tofu | |
| | and different stages of heating. | | |
| Overcooked oil | An aromatic reminiscent of oil overheated | Heated corn oil at 240° C. for | |
| | during processing | 30 minutes. | |
| Nutty | The aromatics associated with a nutty/woody | Most tree nuts: pecans, | |
| | flavor; also a characteristic of walnuts and | almonds, hazelnuts, walnuts | |
| | other nuts. Includes hulls/skins of nuts. | | |
| Milky | The slightly sour, animal, milky aromatic | Skim Milk | |
| | associated with skim milk and milk derived | | |
| | products. | | |
| Barnyard | Aromatic characteristic of a barnyard; | Old casein, white pepper, | |
| | combination of manure, urine, moldy hay, | processed rotten potatoes | |
| | feed, livestock odors | | |
| Animal | Aroma similar to smell of live animal, including | Unprocessed sheep wool | |
| | its hair | | |
| Dairy Fat | The slightly sweet, buttery (real) aromatics | Heavy cream | |
| | associated with dairy fat. | | |
| Diacetyl | The aromatic associated with artificial butter | Artificial Butter, movie theater | |
| | flavoring | popcorn, Hot Buttered | |
| | | Popcorn Jelly Belly | |
| Painty | The solvent aromatic associated with linseed | Aroma of Linseed oil | |
| | oils and moderately oxidized oil. | | |
| Fishy | Aromatic associated with trimethylamine and | Cod liver oil, trimethylamine, | |
| | old fish. | Geisha canned lump crab, | |
| | | oxidized tea bag | |
| Cardboard/Woody | The aromatics associated with dried wood | Toothpicks, Water from | |
| | and the aromatics associated with slightly | cardboard soaked for 1 hour | |
| | oxidized fats and oils, reminiscent of a | | |
| | cardboard box | | |
| BASIC | | | |
| TASTES | | | |
| Sweet | The taste on the tongue stimulated by sucrose | Sucrose solution: | |
| | and other sugars, such as fructose, glucose, | 2% | 2.0 |
| | etc., and by other sweet substances, such as | 5% | 5.0 |
| | saccharin, Aspartame, and Acesulfam-K. | 10% | 10.0 |
| | | 16% | 15.0 |
| Sour | The taste on the tongue stimulated by acid, | Citric acid solution: | |
| | such as citric, malic, phosphoric, etc. | 0.05% | 2.0 |
| | | 0.08% | 5.0 |
| | | 0.15% | 10.0 |
| | | 0.20% | 15.0 |
| Salt | The taste on the tongue associated with | Sodium chloride solution: | |
| | sodium salts. | 0.2% | 2.0 |
| | | 0.35% | 5.0 |
| | | 0.5% | 8.5 |
| | | 0.57% | 10.0 |
| | | 0.7% | 16.0 |
| Bitter | The taste on the tongue associated with | Caffeine solution: | |
| | caffeine and other bitter substances, such as | 0.05% | 2.0 |
| | quinine and hop bitters. | 0.08% | 5.0 |
| | | 0.15% | 10.0 |
| | | 0.20% | 15.0 |
| CHEMICAL | | | |
| FEELING FACTOR | | | |
| Astringent | The shrinking or puckering of the tongue | Alum solution: | |
| | surface caused by substances such as | 0.05% | 3.0 |
| | tannins or alum. | 0.10% | 6.0 |
| | | 0.2% | 9.0 |
| Burn | | | |

Intensities based on Universal Scale:
Baking Soda in Saltine 2.5
Cooked Apple in Applesauce 5.0
Orange in Orange Juice 7.5
Concord Grape in Grape Juice 10.0
Cinnamon in Big Red Gum 12.0

TABLE 4
Lexicon for texture attributes.

| INITIAL | | | |
|---|---|---|---|
| Initial Viscosity | The rate of flow per unit force across | Water | 1.0 |
| | tongue. | Plain Silk | 2.0 |
| | Not viscous/Fast-Viscous/Slow | Light Cream | 2.2 |
| | | Heavy Cream | 3.0 |
| | | Maple Syrup | 6.8 |
| | | Chocolate Syrup | 9.2 |
| | | Dairy Mixture | 11.7 |
| | | Condensed Milk | 14.0 |
| Amount of Particles | The amount of particles perceived in | Miracle Whip | 0.0 |
| | the sample. | Silk | 0.0 |
| | No particles-Many particles | Sour cream + cream of wheat | 5.0 |
| | | Mayo + corn flour | 10.0 |
| Particle Size | The size of the particles perceived in | Add each to vanilla pudding in a 1:1 ratio. | |
| | the sample. (gritty, grainy, lumpy, | Silk (no mixing w/pudding) | 0.0 |
| | etc.) | Vanilla pudding | 0.0 |
| | Very small particles-Very large | Corn starch | 1.0 |
| | particles | My*T*Fine tapioca pudding mix (dry) | 3.5 |
| | | Grape Nuts | 6.5 |
| | | Uncle Ben's white rice (uncooked) | 9.0 |
| | | Tic Tac's | 14.0 |
| TEN MANIPULATIONS | | | |
| Viscosity at 10 | The rate of flow per unit force across | Water | 1.0 |
| Manipulations | tongue. | Plain Silk | 2.2 |
| | Not viscous/Fast-Viscous/Slow | Light Cream | 2.5 |
| | | Heavy Cream | 3.0 |
| | | Maple Syrup | 6.8 |
| | | Chocolate Syrup | 9.2 |
| | | Dairy Mixture | 11.7 |
| | | Condensed Milk | 14.0 |
| Mixes with Saliva | The saliva solubility of the product. | JIF Peanut Butter (smooth) | 5.0 |
| | No mixing-Complete mixing | Mashed Potatoes | 10.0 |
| | | Jello Chocolate Pudding | 13.5 |
| RESIDUAL | | | |
| Chalky Mouthcoating | The amount of coating/film remaining | | |
| | | Silk (Chalky, Tacky) | 1.0 |
| | in the mouth after expectoration | Cooked corn starch | 3.0 |
| | associated with chalky products such | Pureed potato | 8.0 |
| | as milk of magnesia. | Naked Protein Zone | 14.0 |
| | None-A lot | | |
| Slick Mouthcoating | The amount of coating/film remaining | Silk (Chalky, Tacky) | 1.0 |
| | in the mouth after expectoration | Cooked corn starch | 3.0 |
| | associated with slick products such | Pureed potato | 8.0 |
| | as over-ripe fruit. | Naked Protein Zone | 14.0 |
| | None-A lot | | |
| Tacky Mouthcoating | The amount of coating/film remaining | Silk (Chalky, Tacky) | 1.0 |
| | in the mouth after expectoration | Cooked corn starch | 3.0 |
| | associated with tacky products such | Pureed potato | 8.0 |
| | as marshmallow fluff. | Naked Protein Zone | 14.0 |
| | None-A lot | | |
| Oily Mouthcoating | The amount of coating/film remaining | Silk (Chalky, Tacky) | 1.0 |
| | in the mouth after expectoration | Cooked corn starch | 3.0 |
| | None-A lot | Pureed potato | 8.0 |
| | | Naked Protein Zone | 14.0 |

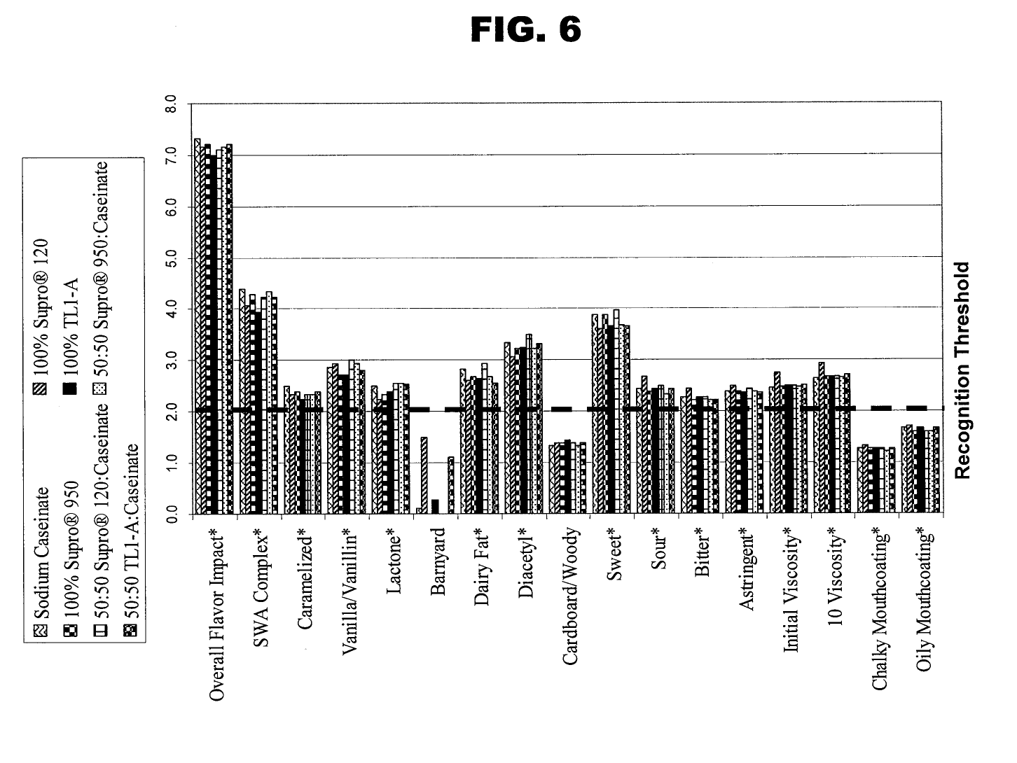

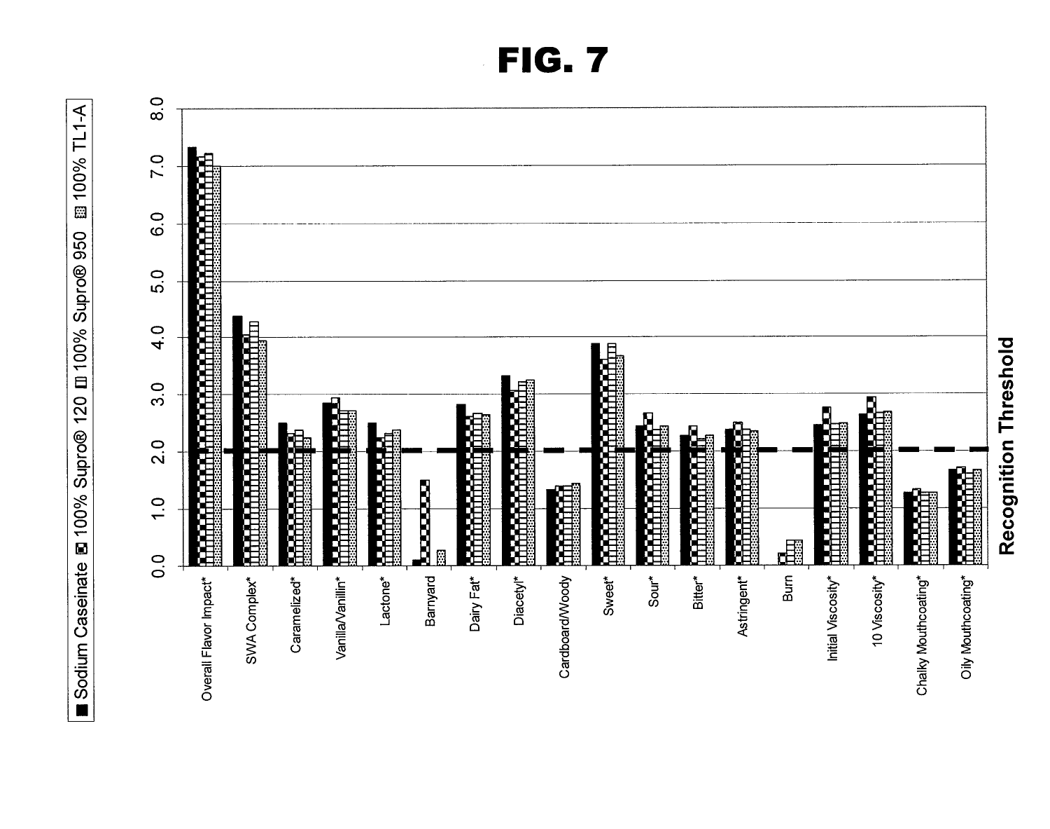

The Overall Flavor Impact attributes including Sweet Aromatic Complex and Sweet then Dairy Fat and Diacetyl associated within the coffee creamer were stronger in intensity than any other attributes associated with soy and dairy (FIGS. 6 and 7). Nevertheless, detectable differences were found between the Sodium Caseinate, 100% SUPRO® 120, 100% SUPRO® 950, 100% TL1-A, 50:50 SUPRO® 120:Caseinate, 50:50 SUPRO® 950:Caseinate, and 50:50 TL1-A.

In regards to coffee creamer aromatics, the Overall Flavor Impact was perceived as stronger in Sodium Caseinate compared to TL1-A (FIG. 6). Sweet Aromatic Complex was perceived as stronger in Sodium Caseinate and 50:SUPRO® 950:Caseinate compared to 100% SUPRO® 120 and TL1-A. Caramelized was perceived as stronger in Sodium Caseinate compared to TL1-A. Vanilla/Vanillin was perceived as stronger in 50:50 SUPRO® 120:Caseinate compared to 100% SUPRO® 950 and 100% TL1-A. Lactone was perceived as stronger in 50:50 SUPRO® 120:Caseinate, 50:SUPRO® 950:Caseinate, and 50:50 TL1-A:Caseinate compared to 100% SUPRO® 120. Hints of Barnyard aromatics were detected at below recognition threshold (<2.0) in 100% SUPRO® 120 and 50:50 SUPRO® 120:Caseinate. 50:50 SUPRO® 120:Caseinate was higher in Dairy Fat aromatics compared to all the other samples except Sodium Caseinate. 50:50 SUPRO® 120:Caseinate was higher in Diacetyl aromatics compared to 100% SUPRO® 950, 100% TL1-A, 100% SUPRO® 120, and 50:50 SUPRO® 950:Caseinate.

In regard to basic tastes and feeling factors, 50:50 SUPRO® 120:Caseinate was higher in Sweet basic taste compared to 100% SUPRO® 120, 100% TL1-A, and 50:50 SUPRO® 950:Caseinate, and 50:50 TL1-A:Caseinate. 100% SUPRO® 120 was higher in Sour and Bitter basic taste compared to all the other samples. 100% SUPRO® 120 was higher in Astringent basic taste compared to 100% TL1-A and 50:50 TL1-A:Caseinate. Hints of Burn were detected at below recognition threshold (<2.0) in 100% SUPRO® 950, 100% TL1-A, 100% SUPRO® 120, and 50:50 SUPRO® 120:Caseinate.

In regard to texture and mouthfeel, 100% SUPRO® 120 was higher in Initial Viscosity and 10 Viscosity compared to all the other samples. 100% SUPRO® 120 was higher in Chalky Mouthcoating compared to 50:50 SUPRO® 950:Caseinate. 100% SUPRO® 120 was higher in Oily Mouthcoating compared to 100% SUPRO® 950, 50:50 SUPRO® 120:Caseinate, and 50:50 SUPRO® 950:Caseinate.

In comparing between Sodium Caseinate, 100% SUPRO® 120, 100% SUPRO® 950, and 100% TL1-A, Sodium Caseinate was higher in Overall Flavor Impact and Caramelized compared to the 100% TL1-A (FIG. 7). Sodium Caseinate and 100% SUPRO® 950 was higher in Sweet Aromatic Complex. Sodium Caseinate was higher in Dairy Fat and Diacetyl compared to 100% SUPRO® 120. 100% SUPRO® 120 was the highest in Barnyard aromatics. 100% SUPRO® 120 was lower in Sweet basic taste compared to Sodium Caseinate and 100% SUPRO® 950. 100% SUPRO® 120 was higher in Sour, Bitter, Initial Viscosity, and 10 Viscosity compared to all the other samples. 100% SUPRO® 120 was higher in Astringent and Oily Mouthcoating compared to SUPRO® 950.

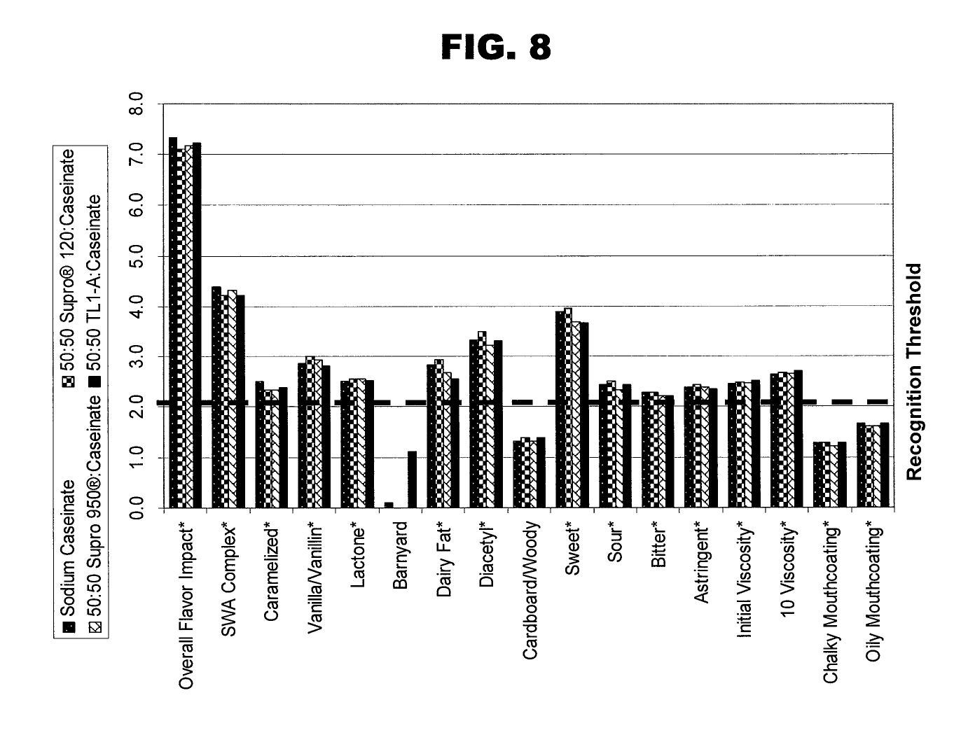

In comparing between Sodium Caseinate, 50:50 SUPRO® 120:Caseinate, 50:50 SUPRO® 950:Caseinate, and 50:50 TL1-A:Caseinate, 50:50 TL1-A:Caseinate was higher in Barnyard aromatics (FIG. 8). 50:50 TL1-A:Caseinate had Burn. 50:50 TL1-A:Caseinate was lower in Dairy Fat aromatics compared to Sodium Caseinate and 50:50 SUPRO® 120:Caseinate. 50:50 TL1-A:Caseinate was higher in Initial Viscosity and 10 Viscosity compared to Sodium Caseinate. 50:50 SUPRO® 120:Caseinate was higher in Sweet compared to 50:50 SUPRO® 950:Caseinate and 50:50 TL1-A:Caseinate.

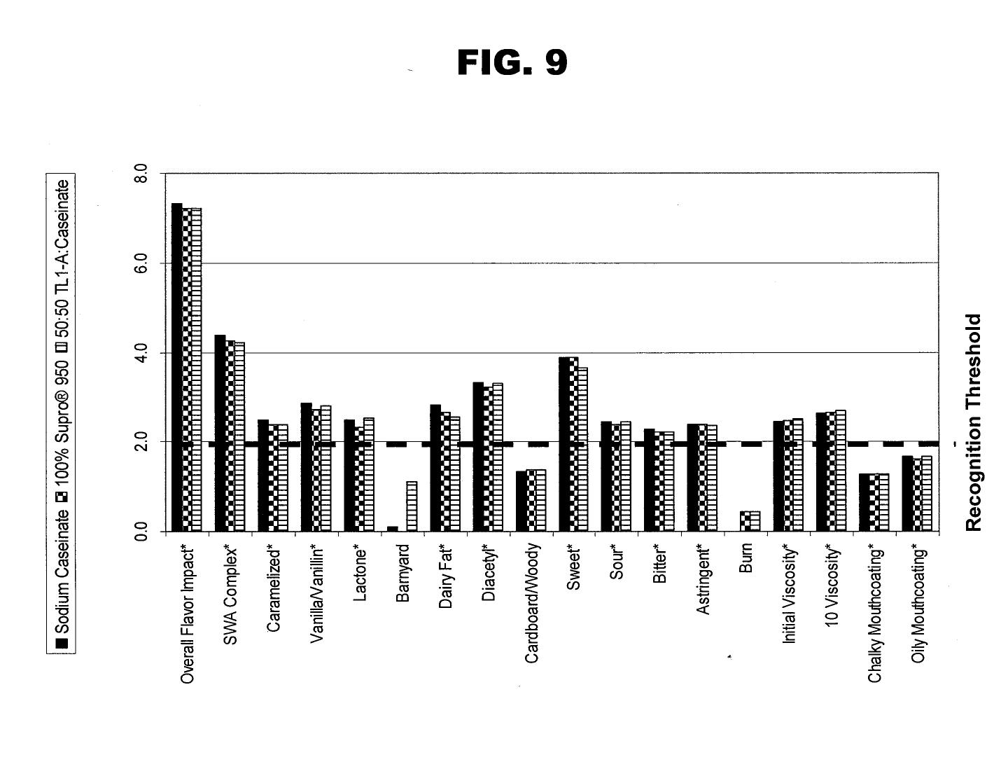

In comparing Sodium Caseinate, 100% SUPRO® 950, and 50:50 TL1-A:Caseinate, Sodium Caseinate had no Burn aromatics (FIG. 9). The 50:50 TL1-A:Caseinate sample was higher in Initial Viscosity and 10 Viscosity and lower in Dairy Fat compared to Sodium Caseinate. The 100% SUPRO® 950 sample has no Barnyard aromatics.

TABLE 5
Mean scores for Flavor Attributes.

| | | 100% | 100% | | | | | | |
|---|---|---|---|---|---|---|---|---|---|
| | Sodium | Supro ® | Supro ® | 100% | 50:50 Supro ® | 50:50 Supro ® | 50:50 TL1- | HSD | p |
| | Caseinate | 120 | 950 | TL1-A | 120:Caseinate | 950:Caseinate | A:Caseinate | value | value |
| Aromatics | | | | | | | | | |
| Overall Flavor | 7.3 a | 7.2 ab | 7.2 ab | 7.0 b | 7.1 ab | 7.2 ab | 7.2 ab | 0.246 | *** |
| Impact | | | | | | | | | |
| Green Complex | 0.0 a | 0.0 a | 0.0 a | 0.0 a | 0.0 a | 0.0 a | 0.0 a | n/a | n/a |
| Grassy | 0.0 a | 0.0 a | 0.0 a | 0.0 a | 0.0 a | 0.0 a | 0.0 a | n/a | n/a |
| Viney | 0.0 a | 0.0 a | 0.0 a | 0.0 a | 0.0 a | 0.0 a | 0.0 a | n/a | n/a |
| Beany | 0.0 a | 0.0 a | 0.0 a | 0.0 a | 0.0 a | 0.0 a | 0.0 a | n/a | n/a |
| SWA Complex | 4.4 a | 4.1 bc | 4.3 ab | 3.9 c | 4.2 ab | 4.3 a | 4.2 ab | 0.236 | *** |
| Caramelized | 2.5 a | 2.3 ab | 2.4 ab | 2.3 b | 2.3 ab | 2.3 ab | 2.4 ab | 0.190 | *** |
| Vanilla/Vanillin | 2.9 ab | 2.9 ab | 2.7 b | 2.7 b | 3.0 a | 2.9 ab | 2.8 ab | 0.270 | *** |
| Lactone | 2.5 ab | 2.3 b | 2.3 ab | 2.4 ab | 2.6 a | 2.6 a | 2.5 a | 0.251 | *** |
| Other SWA | 0.0 a | 0.0 a | 0.0 a | 0.0 a | 0.0 a | 0.0 a | 0.0 a | n/a | n/a |
| Grain | 1.1 a | 1.1 a | 1.1 a | 1.1 a | 1.1 a | 1.1 a | 1.1 a | 0.000 | NS |
| Burnt | 0.0 a | 0.0 a | 0.0 a | 0.0 a | 0.0 a | 0.0 a | 0.0 a | n/a | n/a |
| Soy/Legume | 0.0 a | 0.0 a | 0.0 a | 0.2 a | 0.0 a | 0.0 a | 0.0 a | 0.246 | * |
| Overcooked Oil | 1.2 a | 1.2 a | 1.2 a | 1.2 a | 1.2 a | 1.1 a | 1.2 a | 0.154 | NS |
| Nutty | 1.4 a | 1.3 a | 1.3 a | 1.4 a | 1.4 a | 1.4 a | 1.4 a | 0.079 | * |
| Milky | 0.0 a | 0.0 a | 0.0 a | 0.0 a | 0.0 a | 0.0 a | 0.0 a | n/a | n/a |
| Barnyard | 0.1 b | 1.5 a | 0.0 b | 0.3 b | 0.0 b | 0.0 b | 1.1 a | 0.617 | *** |
| Animal | 0.0 a | a | 0.0 a | 0.0 a | 0.0 a | 0.0 a | 0.0 a | n/a | n/a |
| Dairy Fat | 2.8 ab | 2.6 c | 2.7 bc | 2.6 bc | 2.9 a | 2.7 bc | 2.6 c | 0.212 | *** |
| Diacetyl | 3.3 ab | 3.1 c | 3.2 bc | 3.3 bc | 3.5 a | 3.2 bc | 3.3 ab | 0.244 | *** |
| Painty | 0.0 a | 0.0 a | 0.0 a | 0.0 a | 0.0 a | 0.0 a | 0.0 a | n/a | n/a |
| Fishy | 0.0 a | 0.0 a | 0.0 a | 0.0 a | 0.0 a | 0.0 a | 0.0 a | n/a | n/a |
| Cardboard/Woody | 1.3 b | 1.4 ab | 1.4 ab | 1.4 a | 1.4 ab | 1.3 b | 1.4 ab | 0.099 | ** |
| Basic Tastes & | | | | | | | | | |
| Feeling Factors | | | | | | | | | |
| Sweet | 3.9 ab | 3.6 c | 3.9 ab | 3.7 bc | 4.0 a | 3.7 bc | 3.7 bc | 0.272 | *** |
| Sour | 2.4 bc | 2.7 a | 2.4 bc | 2.4 bc | 2.5 b | 2.3 c | 2.4 bc | 0.162 | *** |
| Salt | 0.9 a | 1.0 a | 0.9 a | 0.9 a | 0.9 a | 0.9 a | 0.9 a | 0.123 | * |
| Bitter | 2.3 b | 2.4 a | 2.2 b | 2.3 b | 2.3 b | 2.2 b | 2.2 b | 0.137 | *** |
| Astringent | 2.4 ab | 2.5 a | 2.4 ab | 2.4 b | 2.4 ab | 2.4 ab | 2.4 b | 0.113 | *** |
| Burn | 0.0 b | 0.2 ab | 0.4 a | 0.4 a | 0.0 b | 0.0 b | 0.4 a | 0.467 | *** |
| Texture/Mouthfeel | | | | | | | | | |
| Initial Viscosity | 2.46 c | 2.76 a | 2.48 bc | 2.49 bc | 2.49 bc | 2.47 bc | 2.52 b | 0.052 | *** |
| Particle Amount | 0.0 a | 0.0 a | 0.0 a | 0.0 a | 0.0 a | 0.0 a | 0.0 a | n/a | n/a |
| Particle Size | 0.0 a | 0.0 a | 0.0 a | 0.0 a | 0.0 a | 0.0 a | 0.0 a | n/a | n/a |
| 10 Viscosity | 2.64 c | 2.94 a | 2.67 bc | 2.68 bc | 2.68 bc | 2.66 bc | 2.71 b | 0.052 | *** |
| Mixes With Saliva | 13.7 a | 13.6 a | 13.7 a | 13.7 a | 13.7 a | 13.7 a | 13.7 a | 0.123 | * |
| Chalky | 1.28 ab | 1.33 a | 1.28 ab | 1.28 ab | 1.28 ab | 1.22 B | 1.28 ab | 0.094 | ** |
| Mouthcoating | | | | | | | | | |
| Slick Mouthcoating | 0.0 a | 0.0 a | 0.0 a | 0.0 a | 0.0 a | 0.0 A | 0.0 a | n/a | n/a |
| Tacky | 0.0 a | 0.0 a | 0.0 a | 0.0 a | 0.0 a | 0.0 A | 0.0 a | n/a | n/a |
| Mouthcoating | | | | | | | | | |
| Oily | 1.7 ab | 1.7 a | 1.6 b | 1.7 ab | 1.6 b | 1.6 B | 1.7 ab | 0.104 | ** |
| Mouthcoating | | | | | | | | | |

¹Means in the same row followed by the same letter are not significantly different at 95% Confidence.
***99% Confidence,
**95% Confidence,
*90% Confidence,
NS—Not Significant
The attributes at threshold or low are not bold.
The attributes above threshold are bold.
For other attributes, % score is the percentage of times the attribute was perceived, and the score is reported as an average value of the detectors

TABLE 6
Mean Scores for Texture Attributes

| | | 100% | 100% | | | | | | |
|---|---|---|---|---|---|---|---|---|---|
| | Sodium | Supro ® | Supro ® | 100% | 50:50 Supro ® | 50:50 Supro ® | 50:50 TL1- | HSD | p |
| | Caseinate | 120 | 950 | TL1-A | 120:Caseinate | 950:Caseinate | A:Caseinate | value | value |
| Texture/Mouthfeel | | | | | | | | | |
| Initial Viscosity | 2.46 c | 2.76 a | 2.48 bc | 2.49 bc | 2.49 bc | 2.47 bc | 2.52 b | 0.052 | *** |
| Particle Amount | 0.0 a | 0.0 a | 0.0 a | 0.0 a | 0.0 a | 0.0 a | 0.0 a | n/a | n/a |
| Particle Size | 0.0 a | 0.0 a | 0.0 a | 0.0 a | 0.0 a | 0.0 a | 0.0 a | n/a | n/a |
| 10 Viscosity | 2.64 c | 2.94 a | 2.67 bc | 2.68 bc | 2.68 bc | 2.66 bc | 2.71 b | 0.052 | *** |
| Mixes With Saliva | 13.7 a | 13.6 a | 13.7 a | 13.7 a | 13.7 a | 13.7 a | 13.7 a | 0.123 | * |
| Chalky | 1.28 ab | 1.33 a | 1.28 ab | 1.28 ab | 1.28 ab | 1.22 b | 1.28 ab | 0.094 | ** |
| Mouthcoating | | | | | | | | | |
| Slick | 0.0 a | 0.0 a | 0.0 a | 0.0 a | 0.0 a | 0.0 a | 0.0 a | n/a | n/a |
| Mouthcoating | | | | | | | | | |
| Tacky | 0.0 a | 0.0 a | 0.0 a | 0.0 a | 0.0 a | 0.0 a | 0.0 a | n/a | n/a |
| Mouthcoating | | | | | | | | | |
| Oily | 1.7 ab | 1.7 a | 1.6 b | 1.7 ab | 1.6 b | 1.6 b | 1.7 ab | 0.104 | ** |
| Mouthcoating | | | | | | | | | |

¹Means in the same row followed by the same letter are not significantly different at 95% Confidence.
***99% Confidence,
**95% Confidence,
*90% Confidence,
NS—Not Significant
The attributes at threshold or low are not bold.
The attributes above threshold are bold.
For other attributes, % score is the percentage of times the attribute was perceived, and the score is reported as an average value of the detectors

### Example 3

### Analysis of 100% Replacement of Sodium Caseinate with Soy Protein Material in a Spray Dried Non-Dairy Creamer Model

Soy protein materials, enzymatically treated to result in different degrees of hydrolysis, were evaluated for functionality and compared to that of Sodium Caseinate while used in a spray dried non-dairy creamer. The spray dried non-dairy creamer model was based on Nestle Coffee-mate, Original, coffee creamer. Specifically, the non-dairy creamer model formulation consisted of 2% protein and 33% total fat. The soy protein materials evaluated included SUPRO® 950 and SPP-A, soy protein hydrolysates and TL1 Hydrolysate having a DH of 3.2%.

Using the formulation listed in Table 11, the soy protein material was incorporated into the model non-dairy creamer using the following process. Phosphates were dispersed in water and the solution heated to 60° C. (140° F.). Proteins were then dispersed in the phosphate water with moderate shear and once protein powder was completely dispersed, the speed of mixing was reduced and the temperature increased to 75° C. (167° F.) with mixing continued for 10 minutes. Sodium stearoyl-2-lactylate and corn syrup solids were added to the hydrated protein and mixing continued for 5 minutes. Dimodan® and Danisco Panodan® were blended with a portion of the vegetable oil at a ratio of 1 part emulsifier to 5 parts oil and this mixture was heated at a temperature less than or equal to 72° C. (162° F.) to completely dissolve the emulsifier. The remainder of the oil was heated to a temperature not to exceed 60° C. (140° F.) and the oil/emulsifier blend was added to it and mixed until completely homogenous. The oil blend was then added to the phosphate/protein/corn syrup slurry and mixed for an additional 3 minutes. The slurry pH was measured and when necessary adjusted to 7.2 using either a 45% KOH solution if pH was below 7.2 and 50% citric acid solution if pH was above 7.6. The final pH of the non-dairy creamer slurry was maintained between about 7.2 and about 7.6. The slurry was then homogenized using a 3-piston, 2-stage Niro 2006 homogenizer at 3000 psi (500 psi, 2^{nd} stage; 2500 psi, 1^{st} stage) and fed to the spray dryer at a nozzle back pressure of 4000 psi. The slurry was spray dried with an inlet temperature of about 288° C. (550° F.) to about 310° C. (590° F.) and an outlet temperature of about 88° C. (190° F.) to about 99° C. (210° F.). The slurry spray drier was equipped with a Spray Systems nozzle 30/2. The final moisture content of the non-dairy creamer ranged from about 1% to about 2%

TABLE 7
Formulations for 100% replacement of Sodium Caseinate with soy protein material in spray dried non-dairy creamer

| | Control | | Supro 950 | | SPP-A | | TL1-A | |
|---|---|---|---|---|---|---|---|---|
| | Protein ingredient: | | | | | | | |
| | | | soy protein | | soy protein | | soy protein | |
| | Na Caseinate | | hydrolysate | | hydrolysate | | hydrolysate | |
| | Formulation | | | | | | | |
| | as is | grams/ | as is | grams/ | as is | grams/ | as is | grams/ |
| Ingredient | 50% TS | 45 kg | 50% TS | 45 kg | 50% TS | 45 kg | 50% TS | 45 kg |
| Water | 50.00 | 22500.00 | 50.00 | 22500.00 | 50.00 | 22500.00 | 50.00 | 22500.00 |
| Corn syrup solids, 25DE | 31.46 | 14157.00 | 31.13 | 14008.50 | 31.13 | 14008.50 | 31.13 | 14008.50 |
| Sodium caseinate | 0.85 | 382.50 | 0.00 | 0.00 | 0.00 | 0.00 | 0.00 | 0.00 |
| Supro 950, soy protein hydrolysate | 0.00 | 0.00 | 1.18 | 531.00 | 0.00 | 0.00 | 0.00 | 0.00 |
| SPP-A, soy protein hydrolysate | 0.00 | 0.00 | 0.00 | 0.00 | 1.18 | 531.00 | 0.00 | 0.00 |
| TL1-A, soy protein hydrolysate | 0.00 | 0.00 | 0.00 | 0.00 | 0.00 | 0.00 | 1.18 | 531.00 |
| Dipotassium phosphate | 0.71 | 319.50 | 0.71 | 319.50 | 0.71 | 319.50 | 0.71 | 319.50 |
| Tripotassium phosphate | 0.48 | 216.00 | 0.48 | 216.00 | 0.48 | 216.00 | 0.48 | 216.00 |
| Coconut oil, part hydrogenated | 15.95 | 7177.50 | 15.45 | 6952.50 | 15.45 | 6952.50 | 15.45 | 6952.50 |
| Danisco Dimodan HSKA | 0.40 | 180.00 | 0.00 | 0.00 | 0.00 | 0.00 | 0.00 | 0.00 |
| Danisco Panodan FDPK (Datem) | 0.00 | 0.00 | 0.90 | 405.00 | 0.90 | 405.00 | 0.90 | 405.00 |
| Danisco SSL | 0.15 | 67.50 | 0.15 | 67.50 | 0.15 | 67.50 | 0.15 | 67.50 |
| TOTAL | 100.00 | 45000.00 | 100.00 | 45000.00 | 100.00 | 45000.00 | 100.00 | 45000.00 |

TABLE 8
Functionality Analysis¹.

| | Control | Supro 950 | SPP-A | TL1-A |
|---|---|---|---|---|
| Physical Property | w/coffee | w/coffee | w/coffee | w/coffee |
| Oiling Off | 0 | M | 0 | 0 |
| Feathering | 0 | 0 | 0 | 0 |
| Color: L-value | 34.91 | 28.36 | 30.67 | 29.36 |
| Color: a-value | 8.34 | 8.74 | 9.03 | 8.83 |
| Color: b-value | 15.22 | 13.50 | 14.61 | 13.88 |
| pH of Coffee Creamer | 5.72 | 5.75 | 5.80 | 5.80 |

¹Oiling off and feathering visual assessment of occurrence: 0 = none; S = slight; M = moderate; H = high

TABLE 9
Proximate Composition and Microbiological Data.

| Assay | Control | Supro 950 | SPP-A | TL1-A |
|---|---|---|---|---|
| Moisture, % | 2.70 | 2.71 | 2.39 | 2.87 |
| Protein, % | 1.59 | 2.68 | 3.01 | 3.01 |
| Fat, total, % | 33.00 | 33.00 | 33.10 | 32.70 |
| Fat, ether extract, % | 5.56 | 22.00 | 29.10 | 16.40 |
| Ash, % | 2.19 | 2.22 | 2.34 | 2.69 |
| Coliforms, MPN/g | <3 | <3 | <3 | <3 |
| E. coli, MPN/g | <3 | <3 | <3 | <3 |
| Salmonella per 25 g | Negative | Negative | Negative | Negative |
| Staphlococcus aureus, | Negative | Negative | Negative | Negative |
| per 0.1 g | | | | |
| Mesophilic Aerobic | 420 | 630 | 640 | 550 |
| Plate Count, cfu/g | | | | |

The non-dairy creamers were evaluated in prepared coffee and the physical properties were measured and results presented in Table 7. Non-dairy creamers containing the soy protein hydrolysates exhibited similar physical properties to the control (sodium caseinate based) creamer and however all had lower L-values.

The proximate and microbiological analyses were conducted on each non-dairy creamer and resulting data are reported in Table 8. Moisture and total fat content of all creamers were similar however the protein content of the soy protein hydrolysate based creamers was nearly double that of the control creamer and ether extract fat levels were three to four times higher. High ether extract fat values would indicate a stable emulsion was not achieved and thus lower L-values would result. Results of the microbiological analysis indicate that all samples are similar and of acceptable quality for consumption.

### Sensory Profiling of Spray Dried Coffee Creamer Blends in Coffee.

Coffee creamers are typically used to whiten and alter the bitterness and acidity of coffee. Sodium Caseinate (a milk protein) is most commonly used in non-dairy creamers (NDC). Sodium caseinate is used because of its functional ability to stabilize fat through the rigors of processing as well as in end product use. It provides very good emulsion stability through processing and storage and functional stability in coffee. A soy protein material was developed to function as and provide an acceptable alternative to sodium caseinate in non-dairy creamer. To understand the attribute differences among various soy protein preparations used in coffee creamers and their similarity to sodium caseinate, a sensory descriptive analysis was conducted. The sensory descriptive analysis compared Caseinate Control, 100% SUPRO® 120, 100% SUPRO® 950, 100% TL1-A, 50:50 SUPRO® 120:Caseinate, 50:50 SUPRO® 950:Caseinate, and 50:50 TL1-A:Caseinate. Seven panelists trained in the Sensory Spectrum Descriptive Profiling method evaluated the samples for 24 flavor and 9 texture attributes. The attributes were evaluated on a 15-point scale, with 0=none/not applicable and 15=very strong/high in each sample. Definitions of the flavor attributes are given in Table 3 and definitions of the texture attributes are given in Table 4.

The samples were prepared by adding 12 grams of each spray dried coffee creamer into 180 mL of brewed coffee. The spray dried coffee creamer was blended until homogenized. The samples were presented monadically in duplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute. See Tables 10 and 11.

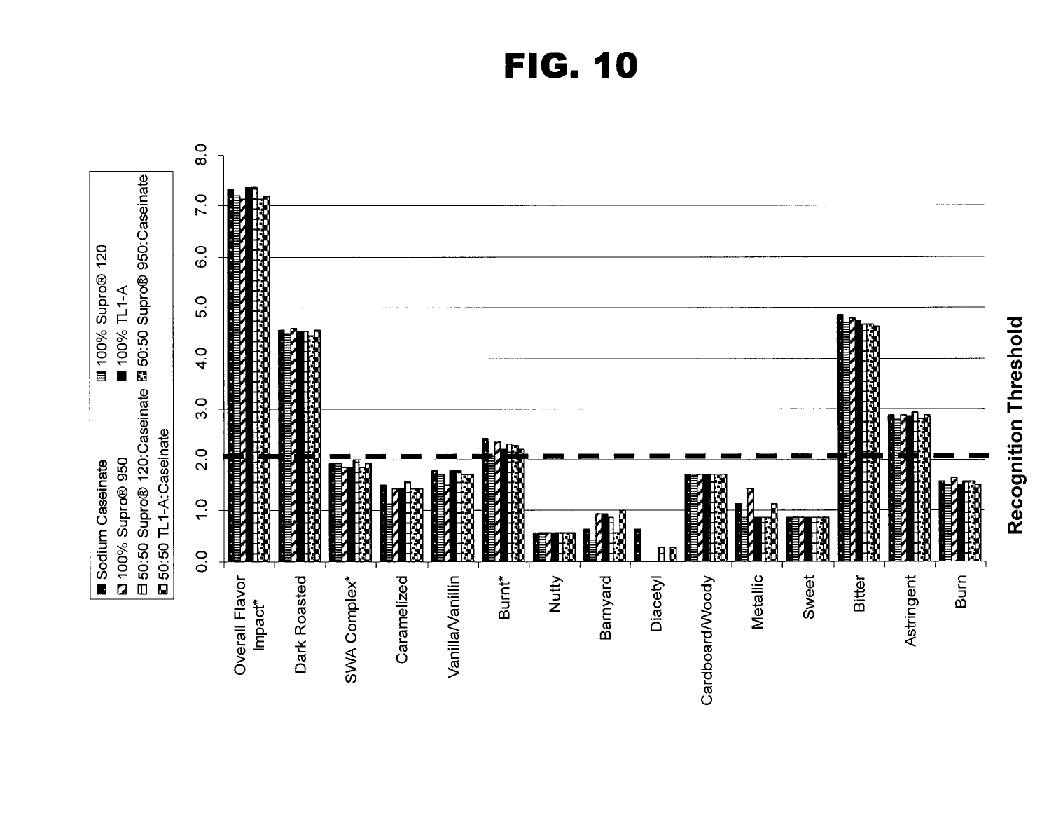

The Overall Flavor Impact attributes including Dark Roasted and Bitter associated within the coffee creamer in coffee were stronger in intensity than any other attributes associated with soy and dairy (FIG. 10). The panelists expressed a difficulty in being able to detect differences between the samples, because the samples were so similar. Nevertheless, detectable differences were found between Sodium Caseinate, 100% SUPRO® 120, 100% SUPRO® 950, 100% TL1-A, 50:50 SUPRO® 120:Caseinate, TL1-A:Caseinate, and 50:50 SUPRO® 950:Caseinate.

In regards to coffee aromatics, the Overall Flavor Impact was perceived as strong in 100% TL1-A and 50:50 SUPRO® 120:Caseinate compared to 100% SUPRO® 950 and 50:50 SUPRO® 950:Caseinate. The Sweet Aromatic Complex was perceived as stronger in the 50:50 SUPRO® 120:Caseinate compared to 100% SUPRO® 950, 100% TL1-A, and 50:50 SUPRO® 950:Caseinate. Hints of Barnyard aromatics were detected at below recognition threshold (<2.0) in Sodium Caseinate, 100% SUPRO® 120, 100% TL1-A, and 50:50 TL1-A:Caseinate. Sodium Caseinate was higher in Burnt aromatics compared to 100% SUPRO® 120, 100% TL1-A, and 50:50 TL1-A:Caseinate.

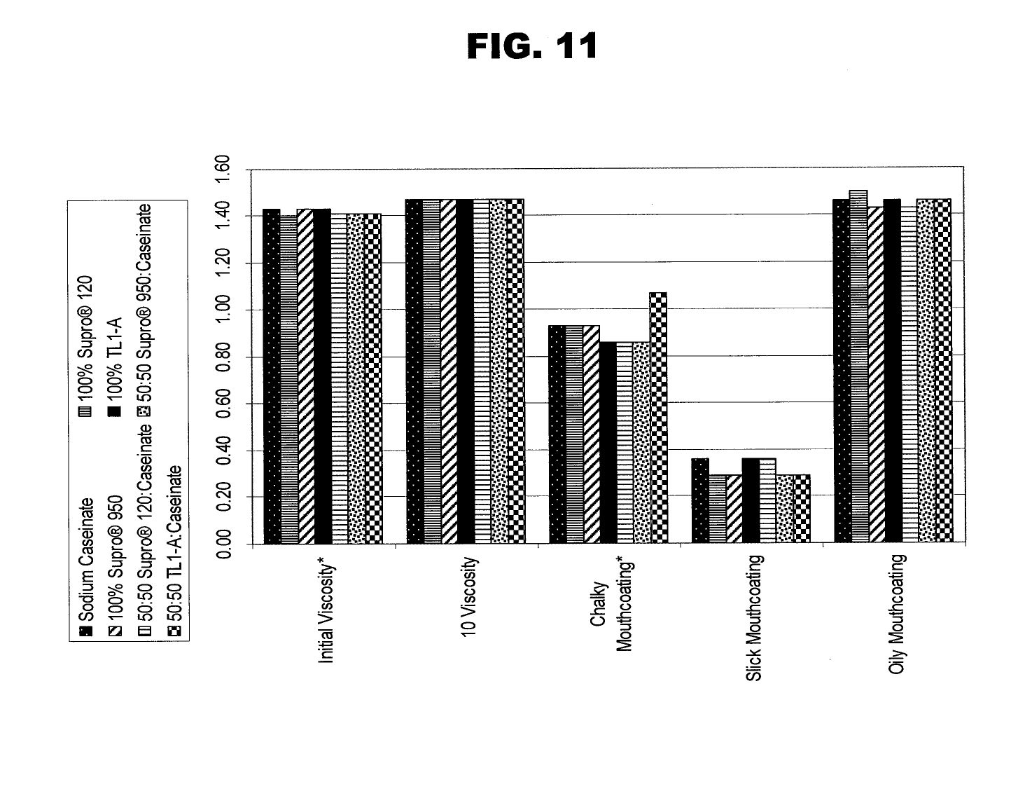

In regard to texture and mouthfeel, 100% SUPRO® 120 was lower in Initial Viscosity compared to all the other samples (FIG. 11) Also, the 50:50 blend of TL1-A:Caseinate was higher in Chalky Mouthcoating compared to all the other samples.

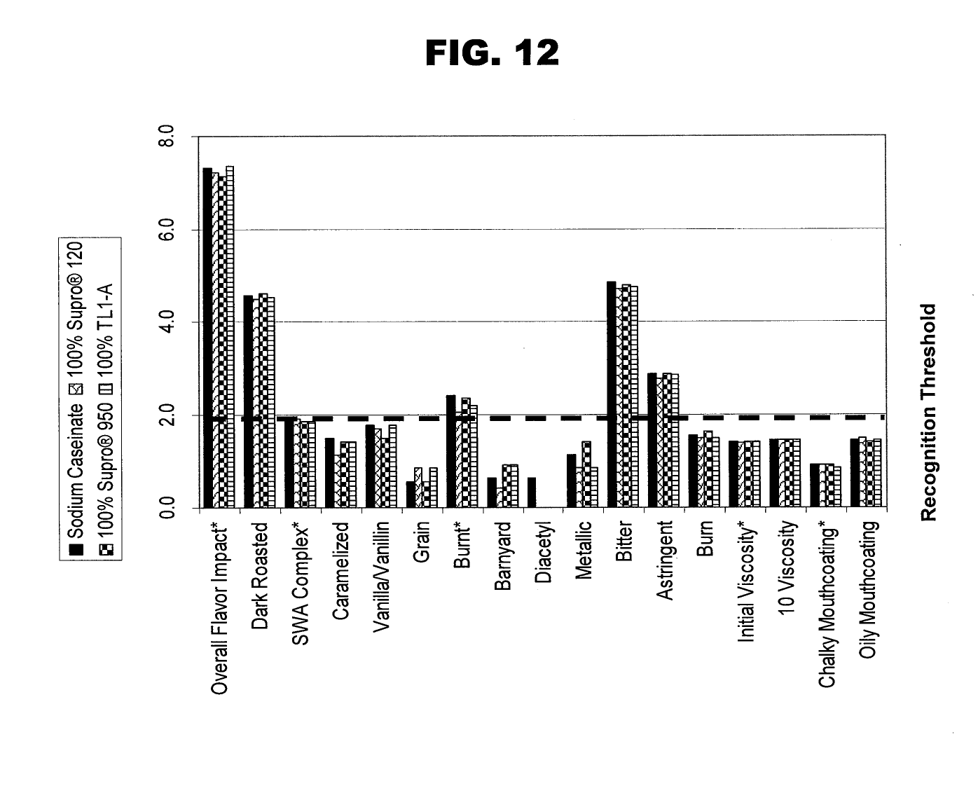

In comparing between Sodium Caseinate, 100% SUPRO® 120, 100% TL1-A, and 100% SUPRO® 950, the 100% TL1-A sample was higher in Overall Flavor Impact compared to the 100% SUPRO® 950 (FIG. 12). Sodium Caseinate was higher in Burnt aromatics compared to 100% SUPRO® 120 and 100% TL1-A. The 100% SUPRO® 120 sampled was lower in Initial Viscosity compared to the other samples.

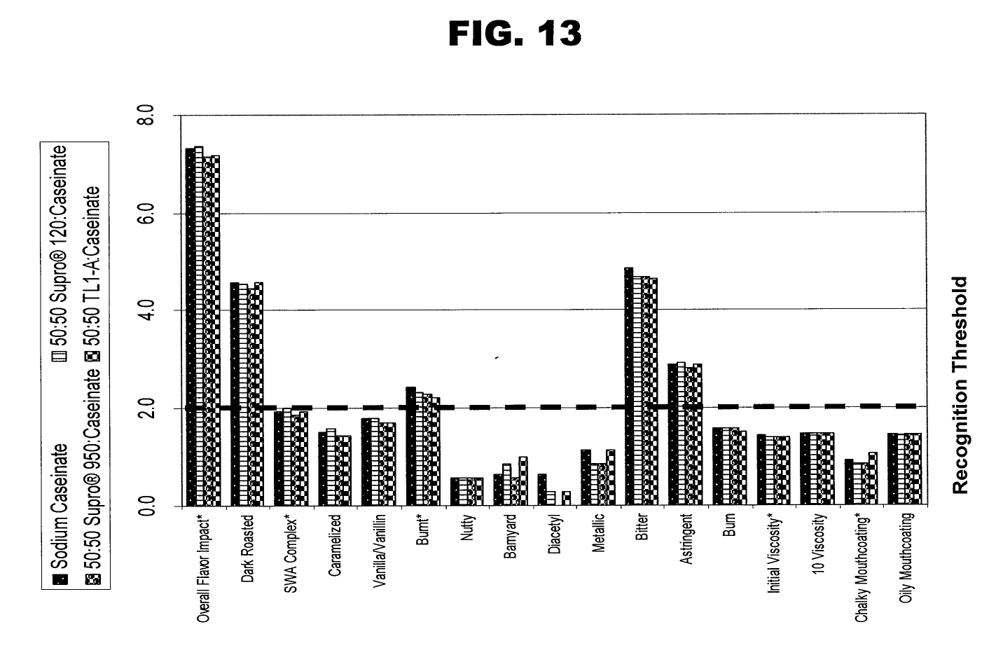

In comparing between Sodium Caseinate, 50:50 SUPRO® 120:Caseinate, 50:50 SUPRO® 950:Caseinate, and 50:50 TL1-A:Caseinate, the 50:50 SUPRO® 120:Caseinate was higher in Overall Flavor Impact and Sweet Aromatic Complex compared to 50:50 SUPRO® 950: Caseinate (FIG. 13). Sodium Caseinate was higher in Burnt aromatics compared to 50:50 SUPRO® 950:Caseinate. Sodium Caseinate was higher in Initial Viscosity compared to the other samples. The 50:50 TL1-A:Caseinate sample was higher in Chalky Mouthcoating compared to 50:50 SUPRO® 120:Caseinate and 50:50 SUPRO® 950:Caseinate.

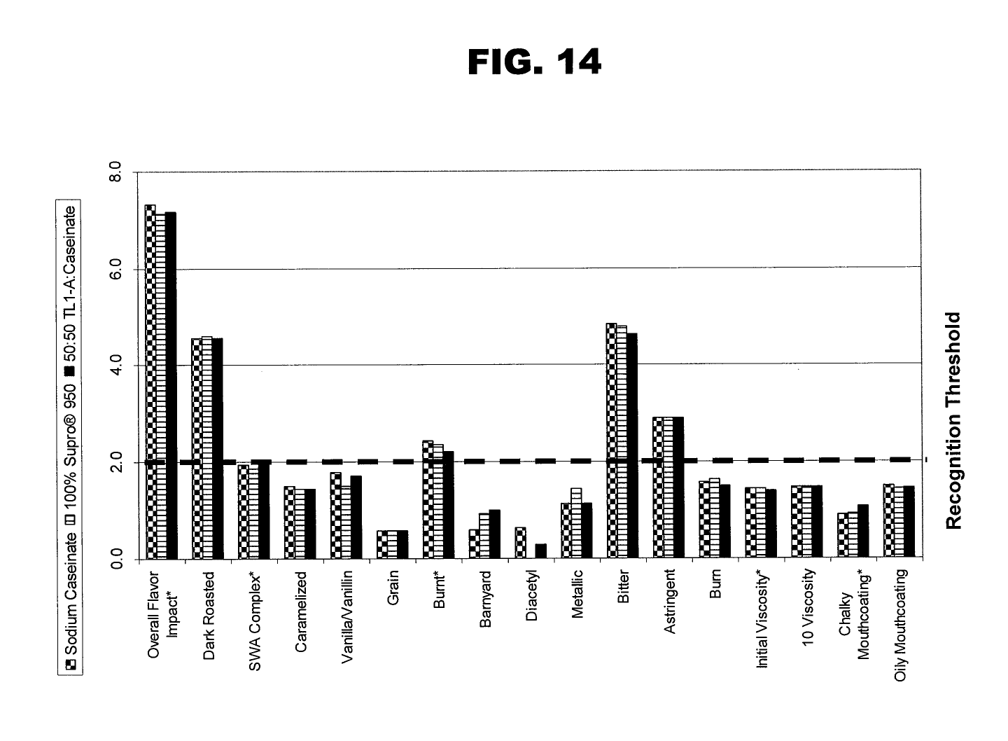

In comparison between Sodium Caseinate, 100% SUPRO® 950, and 50:50 TL1-A:Caseinate, Sodium Caseinate was higher in Burnt aromatics compared to 50:50 TL1-A:Caseinate (FIG. 14). The 50:50 TL1-A:Caseinate sample was higher in Chalky Mouthcoating. The 100% SUPRO® 950 sample was higher in Initial Viscosity.

TABLE 10
Mean Scores for Flavor Attributes.

| | | 100% | 100% | | | | | | |
|---|---|---|---|---|---|---|---|---|---|
| | Sodium | Supro ® | Supro ® | 100% | 50:50 Supro ® | 50:50 Supro ® | 50:50 TL1- | HSD | p |
| | Caseinate | 120 | 950 | TL1-A | 120:Caseinate | 950:Caseinate | A:Caseinate | value | value |
| Texture/Mouthfeel | | | | | | | | | |
| Initial Viscosity | 2.46 c | 2.76 a | 2.48 bc | 2.49 bc | 2.49 bc | 2.47 bc | 2.52 b | 0.052 | *** |
| Particle Amount | 0.0 a | 0.0 a | 0.0 a | 0.0 a | 0.0 a | 0.0 a | 0.0 a | n/a | n/a |
| Particle Size | 0.0 a | 0.0 a | 0.0 a | 0.0 a | 0.0 a | 0.0 a | 0.0 a | n/a | n/a |
| 10 Viscosity | 2.64 c | 2.94 a | 2.67 bc | 2.68 bc | 2.68 bc | 2.66 bc | 2.71 b | 0.052 | *** |
| Mixes With Saliva | 13.7 a | 13.6 a | 13.7 a | 13.7 a | 13.7 a | 13.7 a | 13.7 a | 0.123 | * |
| Chalky | 1.28 ab | 1.33 a | 1.28 ab | 1.28 ab | 1.28 ab | 1.22 b | 1.28 ab | 0.094 | ** |
| Mouthcoating | | | | | | | | | |
| Slick | 0.0 a | 0.0 a | 0.0 a | 0.0 a | 0.0 a | 0.0 a | 0.0 a | n/a | n/a |
| Mouthcoating | | | | | | | | | |
| Tacky | 0.0 a | 0.0 a | 0.0 a | 0.0 a | 0.0 a | 0.0 a | 0.0 a | n/a | n/a |
| Mouthcoating | | | | | | | | | |
| Oily | 1.7 ab | 1.7 a | 1.6 b | 1.7 ab | 1.6 b | 1.6 b | 1.7 ab | 0.104 | ** |
| Mouthcoating | | | | | | | | | |

¹Means in the same row followed by the same letter are not significantly different at 95% Confidence.
***99% Confidence,
**95% Confidence,
*90% Confidence,
NS—Not Significant
The attributes at threshold or low are gray.
The attributes above threshold are black.
For other attributes, % score is the percentage of times the attribute was perceived, and the score is reported as an average value of the detectors

TABLE 11
Mean Scores for Texture Attributes.

| | | 100% | 100% | | | | | | |
|---|---|---|---|---|---|---|---|---|---|
| | Sodium | Supro ® | Supro ® | 100% | 50:50 Supro ® | 50:50 Supro ® | 50:50 TL1- | HSD | |
| | Caseinate | 120 | 950 | TL1-A | 120:Caseinate | 950:Caseinate | A:Caseinate | value | p value |
| Texture & | | | | | | | | | |
| Mouthfeel | | | | | | | | | |
| Initial | 1.43 a | 1.40 c | 1.43 a | 1.43 a | 1.41 b | 1.41 b | 1.41 b | 0.000 | *** |
| Viscosity | | | | | | | | | |
| Particle | 0.0 a | 0.0 a | 0.0 a | 0.0 a | 0.0 a | 0.0 a | 0.0 a | n/a | n/a |
| Amount | | | | | | | | | |
| Particle Size | 0.0 a | 0.0 a | 0.0 a | 0.0 a | 0.0 a | 0.0 a | 0.0 a | n/a | n/a |
| 10 Viscosity | 1.47 a | 1.47 a | 1.47 a | 1.47 a | 1.47 a | 1.47 a | 1.47 a | 0.000 | NS |
| Mixes With | 13.9 a | 13.9 a | 13.9 a | 13.9 a | 13.9 a | 13.9 a | 13.9 a | n/a | n/a |
| Saliva | | | | | | | | | |
| Chalky | 0.9 ab | 0.9 ab | 0.9 ab | 0.9 b | 0.9 b | 0.9 b | 1.1 a | 0.187 | *** |
| Mouthcoating | | | | | | | | | |
| Slick | 0.4 a | 0.3 a | 0.3 a | 0.4 a | 0.4 a | 0.3 a | 0.3 a | 0.111 | * |
| Mouthcoating | | | | | | | | | |
| Tacky | 0.0 a | 0.0 a | 0.0 a | 0.0 a | 0.0 a | 0.0 a | 0.0 a | n/a | n/a |
| Mouthcoating | | | | | | | | | |
| Oily | 1.5 a | 1.5 a | 1.4 a | 1.5 a | 1.4 a | 1.5 a | 1.5 a | 0.111 | NS |
| Mouthcoating | | | | | | | | | |

¹Means in the same row followed by the same letter are not significantly different at 95% Confidence.
***99% Confidence,
**95% Confidence,
*90% Confidence,
NS—Not Significant
The attributes at threshold or low are not bold.
The attributes above threshold are bold.
For other attributes, % score is the percentage of times the attribute was perceived, and the score is reported as an average value of the detectors

Sensory Acceptance of Spray Dried Coffee Creamers in Coffee with 100% Replacement.

To evaluate sensory parity of soy protein as a replacement for Sodium Caseinate, a consumer acceptability analysis of non-dairy creamers based on different protein or combinations of protein having equal nutrient composition were analyzed. Specifically, the following products were tested: Sodium Caseinate, having 2% protein, 33% fat, and flavor added NDC; SUPRO® 120, having 2% protein 33% fat, and flavor added NDC; SUPRO® 950, having 2% protein, 33% fat, and flavor added NDC; TL1-A, having 2% protein, 33% fat, and flavor added NDC; 50:50 blend Caseinate and SUPRO® 120, flavor added NDC; 50:50 blend Caseinate and SUPRO® 950, flavor added NDC; and 50:50 blend Caseinate and TL1-A, flavor added NDC.

The acceptance ratings were compared between non-dairy creamers prepared with Sodium Caseinate and soy protein. Specifically, the products sampled included Sodium Caseinate, 2% protein, 33% fat flavor added NDC; SUPRO® 120, 2% protein, 33% fat, flavor added NDC; SUPRO® 950, 2% protein, 33% fat, flavor added NDC; and TL1-A, 2% protein 33% fat, flavor added NDC.

The samples were evaluated by 75 consumers willing to try coffee with creamer, prescreened as users of coffee whiteners.

Consumers evaluated samples prepared by adding 12 grams of each spray dried coffee creamer to 180 mL of brewed coffee. The spray dried coffee creamer was blended until homogenized in the coffee. The samples were served by sequential monadic presentation (one at a time).

The data was analyzed using the Analysis of Variance (ANOVA) to account for panelist and sample effects, with mean separations using Tukey's Significant Difference (HSD) Test.

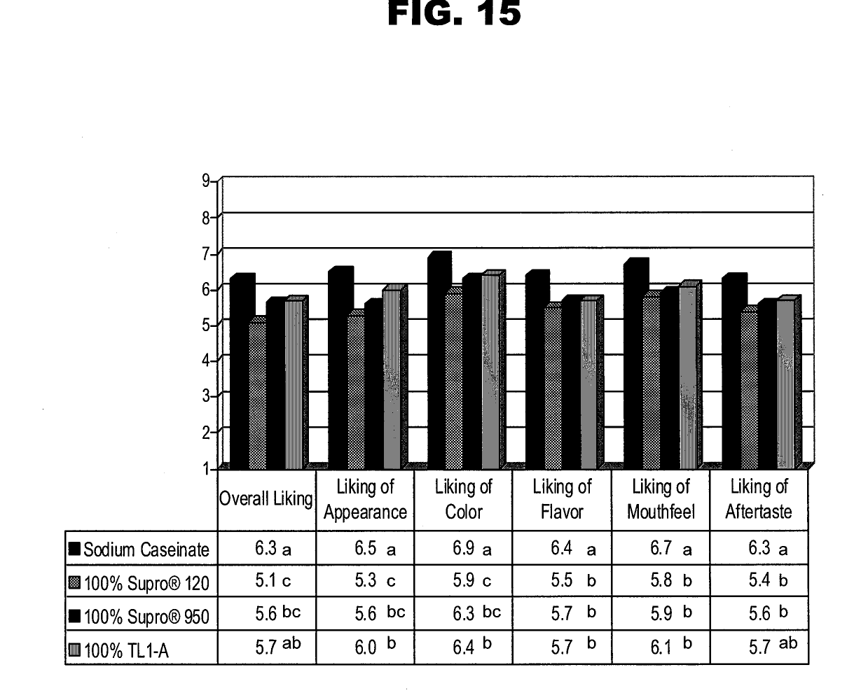

Complete replacement of Sodium Caseinate with soy protein material was not recommended due to reduced consumer acceptability, regardless of the soy protein treatment used. The mean scores for Sodium Caseinate were significantly higher compared to 100% SUPRO® 120 and 100% SUPRO® 950 in Overall Liking (FIG. 15).

### Acceptance of Spray Dried Coffee Creamers in Coffee (50/50 Blends)

The acceptance ratings were compared between non-dairy creamers prepared with Sodium Caseinate and soy protein. Specifically, the products sampled included Sodium Caseinate, 2% protein, 33% fat flavor added NDC; SUPRO® 120, 2% protein, 33% fat, flavor added NDC; SUPRO® 950, 2% protein, 33% fat, flavor added NDC; and TL 1-A, 2% protein 33% fat, flavor added NDC.

Judges evaluated samples prepared by adding 12 grams of each spray dried coffee creamer to 180 mL of brewed coffee. The spray dried coffee creamer was blended until homogenized in the coffee. The samples were served by sequential monadic presentation (one at a time).

The data was analyzed using the Analysis of Variance (ANOVA) to account for panelist and sample effects, with mean separations using Tukey's Significant Difference (HSD) Test.

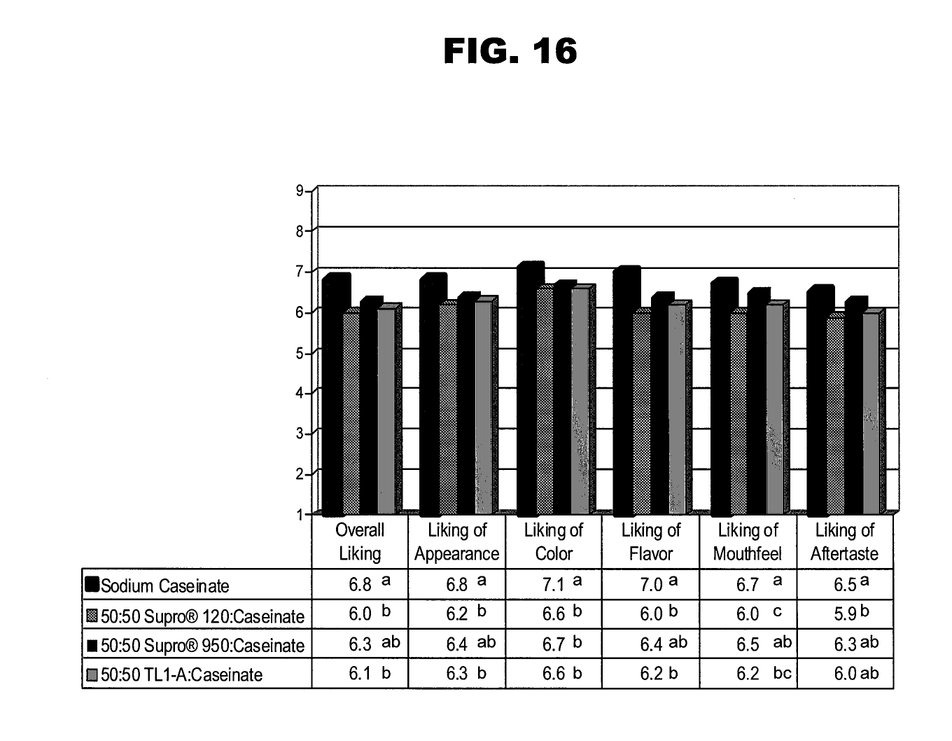

The use of 50% replacement of Sodium Caseinate with SUPRO® 950 is recommended over SUPRO® 120 or TL1-A to achieve parity acceptability. The 50:50 blend of SUPRO® 950:Caseinate scored directionally higher (and second to Sodium Caseinate) compared to the other blends for Overall Liking (FIG. 16), Appearance Liking (FIG. 16), Flavor Liking (FIG. 16), Mouthfeel Liking (FIG. 16), and Aftertaste Liking (FIG. 16).

The mean Overall Liking scores for Sodium Caseinate were significantly higher compared to 50:50 SUPRO® 120:Caseinate and 50:50 TL1-A:Caseinate. The 50:50 SUPRO® 950:Caseinate blend exhibited like similarity to the Sodium Caseinate (FIG. 16).

The mean Color Liking scores for Sodium Caseinate were significantly higher compared to 50:50 SUPRO® 120:Caseinate, 50:50 SUPRO® 950:Caseinate, and 50:50 TL1-A:Caseinate (FIG. 16). Mean Flavor Liking (FIG. 16) and Mouthfeel Liking (FIG. 16) scores were also significantly higher for Sodium Caseinate compared to 50:50 SUPRO® 120:Caseinate and 50:50 TL1-A:Caseinate. Mean Aftertaste Liking (FIG. 16) scores were significantly higher for Sodium Caseinate compared to 50:50 SUPRO® 120:Caseinate.

The mean scores for Sodium Caseinate were significantly higher compared to 50:50 SUPRO® 120:Caseinate and 50:50 TL1-A:Caseinate in Appearance Liking (FIG. 16).

### Example 4

### Formulations Containing 100% Replacement of Sodium Caseinate Replacement in Spray Dried Non-Dairy Creamer

Soy protein material was evaluated for functionality when used in the model non-dairy creamer described in Example 5 at 100% replacement for sodium caseinate. Specifically, soy proteins SSP-A and TL1-A were used to replace 100% of the sodium caseinate in the model non-dairy creamer formulation. For specific formulations see Table 12.

TABLE 12
Formulation for spray dried and agglomerated non-dairy creamers using soy proteins to replace 100% of sodium caseinate.

| | Na Caseinate | | TL1-A | | SSP-A, Flv. 1 | | SSP-A, Flv. 2 | |
|---|---|---|---|---|---|---|---|---|
| | Formulation | | | | | | | |
| | as is | grams/ | as is | grams/ | as is | grams/ | as is | grams/ |
| Ingredient | 50% TS | 45 kg | 50% TS | 45 kg | 50% TS | 45 kg | 50% TS | 45 kg |
| Water | 50.00 | 22500.00 | 50.00 | 22500.00 | 50.00 | 22500.00 | 50.00 | 22500.00 |
| Corn syrup solids, 25DE | 31.42 | 14140.13 | 31.32 | 14095.13 | 31.29 | 14081.63 | 31.10 | 13995.45 |
| Sodium caseinate | 0.85 | 382.50 | 0.00 | 0.00 | 0.00 | 0.00 | 0.00 | 0.00 |
| SSP-A | 0.00 | 0.00 | 0.00 | 0.00 | 0.88 | 396.00 | 0.88 | 396.00 |
| TL1-A | 0.00 | 0.00 | 0.85 | 382.50 | 0.00 | 0.00 | 0.00 | 0.00 |
| Dipotassium phosphate | 0.71 | 319.50 | 0.71 | 319.50 | 0.71 | 319.50 | 0.71 | 319.50 |
| Tripotassium phosphate | 0.48 | 216.00 | 0.48 | 216.00 | 0.48 | 216.00 | 0.48 | 216.00 |
| Coconut oil, WMP 76 | 15.95 | 7177.50 | 15.45 | 6952.50 | 15.45 | 6952.50 | 15.45 | 6952.50 |
| Danisco Dimodan HSKA | 0.40 | 180.00 | 0.00 | 0.00 | 0.00 | 0.00 | 0.00 | 0.00 |
| Danisco Panodan FDPK (Datem) | 0.00 | 0.00 | 1.00 | 450.00 | 1.00 | 450.00 | 1.00 | 450.00 |
| Danisco, Grindsted SSL P55 | 0.15 | 67.50 | 0.15 | 67.50 | 0.15 | 67.50 | 0.15 | 67.50 |
| Flv.1 - Soy Masking Flavor | 0.01 | 5.63 | 0.01 | 5.63 | 0.01 | 5.63 | 0.00 | 0.00 |
| Flv.1 - Milk Flavor | 0.03 | 11.25 | 0.03 | 11.25 | 0.03 | 11.25 | 0.00 | 0.00 |
| Flv.2 - Milk Flavor | 0.00 | 0.00 | 0.00 | 0.00 | 0.00 | 0.00 | 0.23 | 101.25 |
| Flv.2 - Vanilla Flavor | 0.00 | 0.00 | 0.00 | 0.00 | 0.00 | 0.00 | 0.00 | 1.80 |
| TOTAL | 100.00 | 45000.00 | 100.00 | 45000.00 | 100.00 | 45000.00 | 100.00 | 45000.00 |

### Example 5

### Formulations Containing 50% Replacement of Sodium Caseinate Replacement in Spray Dried Non-Dairy Creamer

Soy protein material was evaluated for functionality when used in the model non-dairy creamer described in Example 3 at 50% replacement for sodium caseinate. Specifically, soy proteins SSP-A and TL1-A were used to replace 50% of the sodium caseinate in the model non-dairy creamer formulation. For specific formulations see Table 13.

TABLE 13
Formulation for spray dried and agglomerated non-dairy creamers using soy proteins to replace 50% of sodium caseinate.

| | | | | | TL1-A:SSP- | | | |
|---|---|---|---|---|---|---|---|---|
| | Na Caseinate | | Na Cas:TL1-A | | A:NaCas | | Na Cas:SSP-A | |
| | Reference | | 50:50 | | 25:25:50 | | 50:50 | |
| | Formulation | | | | | | | |
| | as is | grams/ | as is | grams/ | as is | grams/ | as is | grams/ |
| Ingredient | 50% TS | 45 kg | 50% TS | 45 kg | 50% TS | 45 kg | 50% TS | 45 kg |
| Water | 50.00 | 22500.00 | 50.00 | 22500.00 | 50.00 | 22500.00 | 50.00 | 22500.00 |
| Corn syrup solids, 25DE | 31.42 | 14140.13 | 31.42 | 14140.13 | 31.38 | 14122.13 | 31.35 | 14106.38 |
| Sodium caseinate | 0.85 | 382.50 | 0.43 | 191.25 | 0.43 | 191.25 | 0.43 | 191.25 |
| SSP-A, Soy Protein Hydrolysate | 0.00 | 0.00 | 0.00 | 0.00 | 0.25 | 112.50 | 0.50 | 225.00 |
| TL1-A, Soy Protein Hydrolysate | 0.00 | 0.00 | 0.43 | 191.25 | 0.22 | 96.75 | 0.00 | 0.00 |
| Dipotassium phosphate | 0.71 | 319.50 | 0.71 | 319.50 | 0.71 | 319.50 | 0.71 | 319.50 |
| Tripotassium phosphate | 0.48 | 216.00 | 0.48 | 216.00 | 0.48 | 216.00 | 0.48 | 216.00 |
| Coconut oil, WMP 76 | 15.95 | 7177.50 | 15.95 | 7177.50 | 15.95 | 7177.50 | 15.95 | 7177.50 |
| Danisco Dimodan HSKA | 0.40 | 180.00 | 0.40 | 180.00 | 0.40 | 180.00 | 0.40 | 180.00 |
| Danisco Panodan FDPK (Datem) | 0.00 | 0.00 | 0.00 | 0.00 | 0.00 | 0.00 | 0.00 | 0.00 |
| Danisco, Grindsted SSL P55 | 0.15 | 67.50 | 0.15 | 67.50 | 0.15 | 67.50 | 0.15 | 67.50 |
| Quest Soy Masking Flavor DY04448 | 0.01 | 5.63 | 0.01 | 5.63 | 0.01 | 5.63 | 0.01 | 5.63 |
| TM Condensed Milk Flavor | 0.03 | 11.25 | 0.03 | 11.25 | 0.03 | 11.25 | 0.03 | 11.25 |
| TOTAL | 100.00 | 45000.00 | 100.00 | 45000.00 | 100.00 | 45000.00 | 100.00 | 45000.00 |

Using the formulations listed in Table 12 and Table 13, the sodium caseinate and/or soy protein material was incorporated into the model non-dairy creamer using the following process. Phosphates are dispersed in water and the solution heated to 60° C. (140° F.). Proteins are then dispersed in the phosphate water with moderate shear and once protein powder is completely dispersed, the speed of mixing is reduced and the temperature increased to 75° C. (167° F.) with mixing continued for 10 minutes. Sodium stearoyl-2-lactylate and corn syrup solids are added to the hydrated protein and mixing continued for 5 minutes. Dimodan® and Panodan® are blended with a portion of the vegetable oil at a ratio of 1 part emulsifier to 5 parts oil and this mixture heated at a temperature not to exceed 72° C. (162° F.) to completely dissolve the emulsifier. The remainder of the oil is heated to a temperature not to exceed 60° C. (140° F.) and the oil/emulsifier blend is added to it and mixed until completely homogenous. The oil blend is then added the phosphate/protein/corn syrup slurry and mixing continued for an additional 3 minutes. The slurry pH is measured and if necessary adjusted to 7.2 using either a 45% KOH solution if pH is below 7.2 and 50% citric acid solution if pH is above 7.6. The final pH of the non-dairy creamer slurry should be maintained between 7.2 and 7.6. The slurry is then homogenized using a 3-piston, 2-stage Niro 2006 homogenizer at 3000 psi (500 psi, 2^{nd} stage; 2500 psi, 1^{st} stage) and fed to the spray dryer at a nozzle back pressure of 4000 psi. The slurry is spray dried with an inlet temperature of about 288° C. (550° F.) to about 310° C. (590° F.) and an outlet temperature of about 88° C. (190° F.) to about 99° C. (210° F.). The slurry spray drier is equipped with a Spray Systems nozzle 30/2. The final moisture content of the non-dairy creamer ranged from about 1% to about 2% (Table 14 and Table 16).

Proximate composition and microbiological analyses were conducted on the spray dried non-dairy creamers and resulting data is reported ted in Table 14 (100% replacement of sodium caseinate) and Table 16 (50% replacement of sodium caseinate). Proximate composition and microbiological analyses show that all spray dried non-dairy creamers were similar in composition and met acceptable and safe microbiological standards for sensory testing.
The physical properties of the spray dried non-dairy creamers in Example 4 and Example 5 are presented in Table 15 (100% replacement of sodium caseinate) and Table 17 (50% replacement of sodium caseinate). The physical properties of all spray dried non-dairy creamers are very similar to the sodium caseinate based spray dried non-dairy creamer. Based on these data TL1-A soy protein and SSP-A soy protein are acceptable as alternatives to sodium caseinate in spray dried and agglomerated non-dairy creamers.

TABLE 14
Proximate composition and microbiological data for Example
10 spray dried and agglomerated non-dairy creamers.

| | | | SSP-A, | SSP-A, |
|---|---|---|---|---|
| | NaCas | TL1-A | Flv. 1 | Flv. 2 |
| Proximate composition: | | | | |
| Moisture, % | 1.17 | 1.45 | 1.49 | 1.69 |
| Protein, % | 1.57 | 1.65 | 1.79 | 1.57 |
| Fat, % (Total Fat) | 33.50 | 33.90 | 33.90 | 33.00 |
| Fat, % (Free Fat) | 2.73 | 16.90 | 22.50 | 23.20 |
| Ash, % | 2.04 | 1.91 | 2.27 | 2.18 |
| Microbiological, | | | | |
| pre-agglomeration | | | | |
| Coliform, Total MPN/g | <3 | <3 | <3 | <3 |
| E. coli, MPN/g | <3 | <3 | <3 | <3 |
| Salmonella, per 25 g | Negative | Negative | Negative | Negative |
| S. Aureus, per 0.1 g | Negative, | Negative, | Negative, | Negative, |
| Mesophilic Aerobic | 220 | 40 | 190 | 1300 |
| Plate, cfu/g | | | | |
| Mold, cfu/g | <10 | <10 | <10 | <10 |
| Yeast, cfu/g | <10 | <10 | <10 | <10 |

TABLE 15
Physical properties of example 10 spray dried
and agglomerated non-dairy creamers.

| | | | SSP-A, | SSP-A, |
|---|---|---|---|---|
| | NaCas | TL1-A | Flv. 1 | Flv. 2 |
| In coffee, pre- | | | | |
| agglomeration: | | | | |
| Color, L-value | 31.06 | 30.49 | 30.67 | 28.15 |
| | 31.23 | 30.6 | 30.96 | 28.7 |
| Color, a-value | 8.68 | 8.89 | 8.97 | 9.26 |
| | 8.65 | 8.89 | 8.99 | 9.14 |
| Color, b-value | 14.66 | 14.54 | 14.69 | 13.97 |
| | 14.69 | 14.59 | 14.81 | 14.12 |
| Oiling off | Slight | none | none | none |
| | Moderate | none | none | none |
| Feathering | none | none | none | none |
| | none | none | none | none |
| pH | 5.85 | 5.87 | 5.94 | 5.87 |
| In coffee, post | | | | |
| agglomeration: | | | | |
| Color, L-value | 33.21 | 30.41 | 30.31 | 27.81 |
| | 32.7 | 29.93 | 30.11 | 26.94 |
| Color, a-value | 8.88 | 9.16 | 9.08 | 9.08 |
| | 8.89 | 8.98 | 9.00 | |
| Color, b-value | 15.46 | 13.71 | 14.63 | 13.71 |
| | 15.33 | 14.43 | 14.53 | |
| Oiling off | none | none | none | none |
| | none | none | none | |
| Feathering | none | none | none | none |
| | none | none | none | |
| pH | 5.74 | 5.85 | 5.84 | 5.81 |
| | 5.81 | 5.86 | 5.86 | |

TABLE 16
Proximate composition and microbiological data of Example
11 spray dried and agglomerated non-dairy creamers.

| | Na | NaCas: | TL1-A:SSP- | Na Cas: |
|---|---|---|---|---|
| | Caseinate | TL1-A | A:NaCas | SSP-A |
| | Reference | 50:50 | 25:25:50 | 50:50 |
| Assay | | | | |
| Moisture, % | 1.17 | 1.12 | 1.06 | 1.37 |
| Protein, % | 1.57 | 1.73 | 1.65 | 1.93 |
| Fat, % (Total Fat) | 33.50 | 32.30 | 32.80 | 33.00 |
| Fat, % (Free Fat) | 2.73 | 2.94 | 3.26 | 3.62 |
| Ash, % | 2.04 | 2.31 | 2.18 | 2.36 |
| Microbiological, | | | | |
| pre-agglomeration | | | | |
| Coliform, Total | <3 | <3 | <3 | <3 |
| MPN/g | | | | |
| E. coli, MPN/g | <3 | <3 | <3 | <3 |
| Salmonella, per 25 g | Negative | Negative | Negative | Negative |
| S. Aureus, per 0.1 g | Negative, | Negative, | Negative, | Negative, |
| Mesophilic Aerobic | 220 | 70 | 20 | 340 |
| Plate, cfu/g | | | | |
| Mold, cfu/g | <10 | <10 | <10 | <10 |
| Yeast, cfu/g | <10 | <10 | <10 | <10 |

TABLE 17
Physical properties of example 11 spray dried
and agglomerated non-dairy creamers.

| | Na | NaCas: | TL1-A:SSP- | Na Cas: |
|---|---|---|---|---|
| | Caseinate | TL1-A | A:NaCas | SSP-A |
| | Reference | 50:50 | 25:25:50 | 50:50 |
| In coffee, pre- | | | | |
| agglomeration: | | | | |
| Color, L-value | 31.06 | 29.99 | 31.03 | 32.53 |
| | 31.23 | 29.73 | 31.2 | 32.57 |
| Color, a-value | 8.68 | 8.95 | 8.86 | 9.03 |
| | 8.65 | 9.02 | 8.98 | 9.2 |
| Color, b-value | 14.66 | 14.66 | 14.78 | 15.43 |
| | 14.69 | 14.53 | 14.95 | 15.56 |
| Oiling off | Slight | Slight | very slight | none |
| | Moderate | Slight | slight | very slight |
| Feathering | none | none | none | none |
| | none | none | none | none |
| pH | 5.85 | 5.8 | 5.82 | 5.76 |
| In coffee, post | | | | |
| agglomeration: | | | | |
| Color, L-value | 33.21 | 31.8 | 32.3 | 31.71 |
| | 32.7 | 30.72 | 31.74 | 32.34 |
| Color, a-value | 8.88 | 9.04 | 9.03 | 9.34 |
| | 8.89 | 9.04 | 9.03 | 9.32 |
| Color, b-value | 15.46 | 15.19 | 15.36 | 15.41 |
| | 15.33 | 14.86 | 15.16 | 15.56 |
| Oiling off | none | very slight | none | slight |
| | none | very slight | none | none |
| Feathering | none | none | none | none |
| | none | none | none | none |
| pH | 5.74 | 5.78 | 5.74 | 5.79 |
| | 5.81 | 5.79 | 5.78 | 5.83 |

### Example 6

### Sensory Profiling of Agglomerated Coffee Creamer Blends in Coffee

Sensory descriptive analysis compared Sodium Caseinate, 100% TL1-A, 100% SSP-A flavor system 1, 100% SSP-A flavor system 2, 50:50 TL1-A:Caseinate, 50:50 SSP-A:Caseinate, and 25:25:50 TL1-A:SSP-A:Caseinate. Eight panelists trained in the Sensory Spectrum Descriptive Profiling method evaluated the samples for 24 flavor and 9 texture attributes. The attributes were evaluated on a 15-point scale, with 0=none/not applicable and 15=very strong/high in each sample. Definitions of the flavor attributes are given in Table 3 and definitions of the texture attributes are given in Table 4.

The samples were prepared by adding 12 grams of each spray dried non dairy coffee creamer into 180 mL of brewed coffee. The spray dried coffee creamer was blended until homogenized. The samples were presented monadically in duplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute. See Tables 18 and 19.

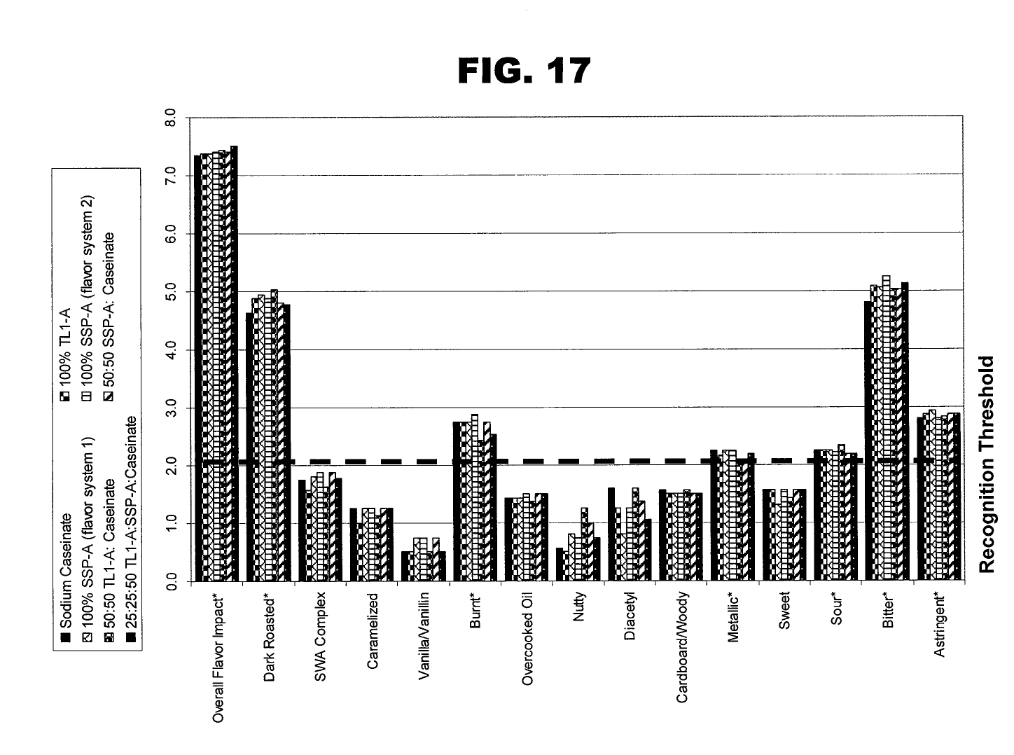

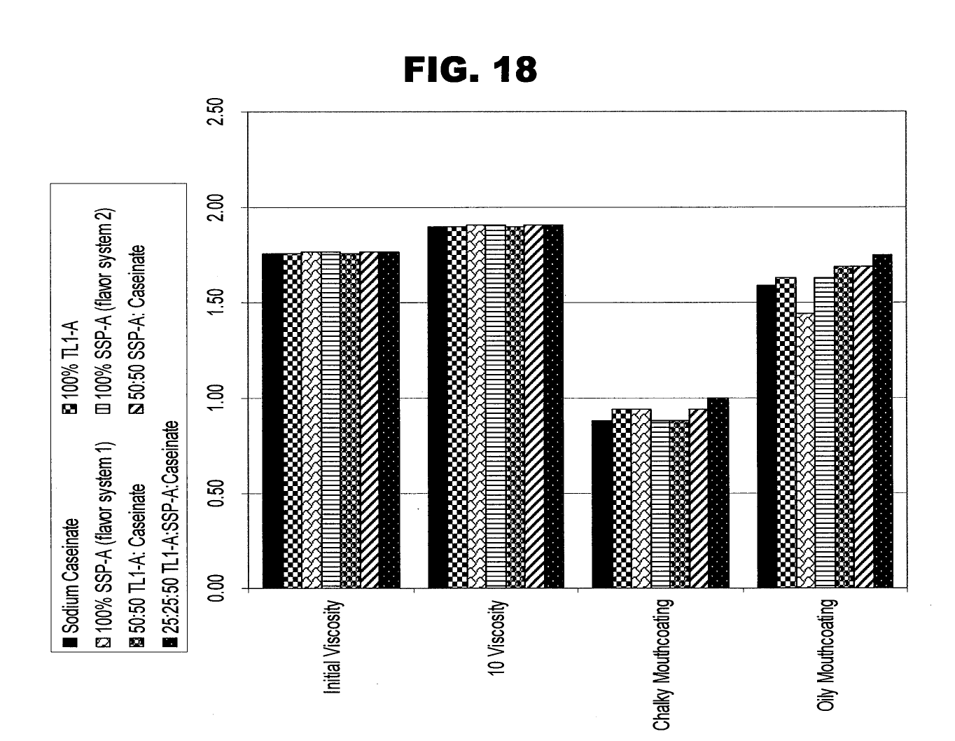

The Overall Flavor Impact attributes including Dark Roasted and Bitter associated within the coffee creamer in coffee were stronger in intensity than any other attributes associated with soy and dairy (FIGS. 17 and 18). The panelists expressed a difficulty in being able to detect differences between the samples, because the samples were so similar. Nevertheless, detectable differences were found between Sodium Caseinate, 100% TL1-A, 100% SSP-A flavor system 1, 100% SSP-A flavor system 2, 50:50 TL1-A:Caseinate, 50:50 SSP-A:Caseinate, and 25:25:50 TL1-A:SSP-A:Caseinate.

Sodium Caseinate was lower in Dark Roasted aromatics, Nutty aromatics, Bitter basic taste as well as being higher in Diacetyl aromatics.

100% TL1-A was lower in Nutty aromatics. 100% SSP-A flavor system 1 was lower in Diacetyl aromatics and Oily Mouthcoating. 100% SSP-A flavor system 2 was higher in Burnt aromatics and Bitter basic taste. 50:50 SSP-A:Caseinate was mid range for all attributes. 25:25:50 TL1-A:SSP-A:Caseinate was higher in Oily Mouthcoating.

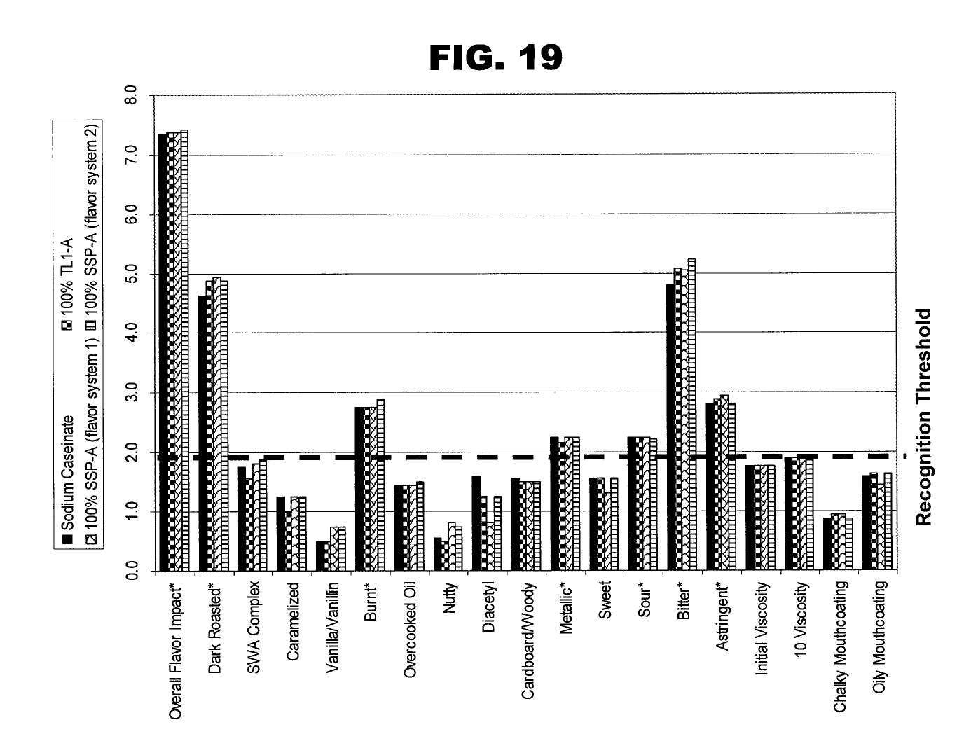

In comparing between Sodium Caseinate, 100% TL1-A, 100% SSP-A flavor system 1 and 100% SSP-A flavor system 2, 100% SSP-A flavor system 1 sample was higher in Astringent basic taste compared to Sodium Caseinate and 100% sC 8.7 flavor system 2 (FIG. 19). The 100% SSP-A flavor system 1 sample was lower in Diacetyl aromatics compared to Sodium Caseinate. The 100% SSP-A flavor system 2 sample was higher in Bitter basic taste compared to Sodium Caseinate. Both 100% SSP-A flavor system 1 and 100% SSP-A flavor system 2 were both higher in Initial and 10 Viscosity compared to Sodium Caseinate and 100% TL1-A.

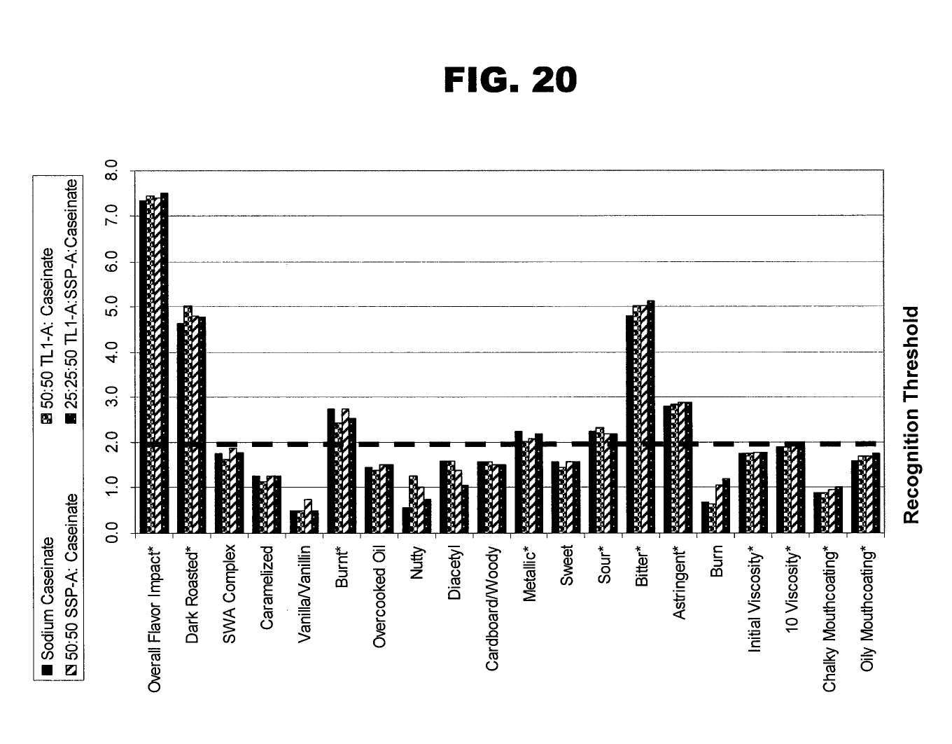

In comparing between Sodium Caseinate, 50:50 TL1-A:Caseinate, 50:50 SSP-A:Caseinate, and 25:25:50 TL1-A:SSP-A:Caseinate, the 50:50 TL1-A:Caseinate sample was higher in Dark Roasted and Nutty aromatics compared to Sodium Caseinate (FIG. 20). The 50:50 TL1-A:Caseinate sample was higher in Sour basic taste compared to 50:50 SSP-A:Caseinate and 25:25:50 TL1-A:SSP-A:Caseinate. The 50:50 TL1-A:Caseinate sample was lower in Burnt aromatics compared to Sodium Caseinate and 50:50 SSP-A:Caseinate. The 50:50 TL1-A:Caseinate sample was lower in Metallic aromatics compared to Sodium Caseinate. The 25:25:50 TL1-A:SSP-A:Caseinate sample was higher in Chalky Mouthcoating compared to Sodium Caseinate and TL1-A:Caseinate. The 25:25:50 TL1-A:SSP-A:Caseinate samples were higher in Initial Viscosity and 10 Viscosity compared to the other samples.

TABLE 18
Mean Scores for Flavor Attributes.

| | | | 100% | 100% | | | | | |
|---|---|---|---|---|---|---|---|---|---|
| | | | SSP-A | SSP-A | | | | | |
| | | | (flavor | (flavor | | | 25:25:50 | | |
| | Sodium | 100% | system | system | 50:50 | 50:50 | TL1-A:SSP- | HSD | p |
| | Caseinate | TL1-A | 1) | 2) | TL1-A:Caseinate | SSP-A:Caseinate | A:Caseinate | value | value |
| Aromatics | | | | | | | | | |
| Overall Flavor | 7.3 ab | 7.4 ab | 7.4 ab | 7.4 ab | 7.4 a | 7.4 ab | 7.5 a | 0.310 | ** |
| Impact | | | | | | | | | |
| Dark Roasted | 4.6 bc | 4.9 abc | 4.9 ab | 4.9 abc | 5.0 a | 4.8 abc | 4.8 abc | 0.318 | *** |
| SWA Complex | 1.8 a | 1.6 a | 1.8 a | 1.9 a | 1.6 a | 1.9 a | 1.8 a | 0.393 | NS |
| Caramelized | 1.3 a | 1.0 a | 1.3 a | 1.3 a | 1.1 a | 1.3 a | 1.3 a | 0.371 | * |
| Vanilla/Vanillin | 0.5 a | 0.5 a | 0.8 a | 0.8 a | 0.5 a | 0.8 a | 0.5 a | 0.400 | NS |
| Lactone | 0.0 | 0.0 | 0.0 | 0.0 | 0.0 | 0.0 | 0.0 | n/a | n/a |
| Grain | 0.0 | 0.0 | 0.0 | 0.0 | 0.0 | 0.0 | 0.0 | n/a | n/a |
| Burnt | 2.8 ab | 2.8 ab | 2.8 ab | 2.9 a | 2.4 c | 2.8 ab | 2.5 bc | 0.265 | *** |
| Soy/Legume | 0.0 | 0.0 | 0.0 | 0.0 | 0.0 | 0.0 | 0.0 | n/a | n/a |
| Overcooked Oil | 1.4 a | 1.4 a | 1.4 a | 1.5 a | 1.4 a | 1.5 a | 1.5 a | 0.134 | * |
| Nutty | 0.6 b | 0.5 b | 0.8 ab | 0.8 ab | 1.3 a | 1.0 ab | 0.8 ab | 0.682 | ** |
| Milky | 0.0 | 0.0 | 0.0 | 0.0 | 0.0 | 0.0 | 0.0 | n/a | n/a |
| Barnyard | 0.0 | 0.0 | 0.0 | 0.0 | 0.0 | 0.0 | 0.0 | n/a | n/a |
| Diacetyl | 1.6 a | 1.3 ab | 0.8 b | 1.3 ab | 1.6 a | 1.4 ab | 1.1 ab | 0.579 | *** |
| Fishy | 0.0 a | 0.0 a | 0.0 a | 0.0 a | 0.0 a | 0.0 a | 0.0 a | 0.265 | * |
| Cardboard/Woody | 1.6 a | 1.5 a | 1.5 a | 1.5 a | 1.6 a | 1.5 a | 1.5 a | 0.111 | NS |
| Metallic | 2.3 ab | 2.2 abc | 2.3 ab | 2.3 ab | 2.0 c | 2.1 bc | 2.2 abc | 0.212 | *** |
| Chemical | 0.0 | 0.0 | 0.0 | 0.0 | 0.0 | 0.0 | 0.0 | n/a | n/a |
| Basic Tastes & | | | | | | | | | |
| Feeling Factors | | | | | | | | | |
| Sweet | 1.6 a | 1.6 a | 1.3 a | 1.6 a | 1.4 a | 1.6 a | 1.6 a | 0.321 | NS |
| Sour | 2.3 ab | 2.3 ab | 2.3 ab | 2.2 ab | 2.3 a | 2.2 b | 2.2 b | 0.153 | ** |
| Salt | 0.6 | 0.6 | 0.6 | 0.6 | 0.6 | 0.6 | 0.6 | n/a | n/a |
| Bitter | 4.8 bc | 5.1 ab | 5.1 ab | 5.3 a | 5.0 ab | 5.0 ab | 5.1 ab | 0.355 | *** |
| Astringent | 2.8 b | 2.9 ab | 2.9 a | 2.8 b | 2.8 ab | 2.9 ab | 2.9 ab | 0.117 | ** |
| Burn | 0.7 ab | 0.8 ab | 0.9 ab | 1.1 ab | 0.6 b | 1.1 ab | 1.2 a | 0.579 | *** |

¹Means in the same row followed by the same letter are not significantly different at 95% Confidence.
***99% Confidence,
**95% Confidence,
*90% Confidence,
NS—Not Significant
The attributes at threshold or low are not bold.
The attributes above threshold are bold.
For other attributes, % score is the percentage of times the attribute was perceived, and the score is reported as an average value of the detectors

TABLE 19
Mean Scores for Texture Attributes.

| | | | 100% | 100% | | | | | |
|---|---|---|---|---|---|---|---|---|---|
| | | | SSP-A | SSP-A | | | | | |
| | | | (flavor | (flavor | | | 25:25:50 | | |
| | Sodium | 100% | system | system | 50:50 | 50:50 | TL1-A:SSP- | HSD | p |
| | Caseinate | TL1-A | 1) | 2) | TL1-A:Caseinate | SSP-A:Caseinate | A:Caseinate | value | value |
| Texture & | | | | | | | | | |
| Mouthfeel | | | | | | | | | |
| Initial | 1.76 b | 1.76 b | 1.77 a | 1.77 a | 1.76 b | 1.77 a | 1.77 a | 0.000 | *** |
| Viscosity | | | | | | | | | |
| 10 Viscosity | 1.90 b | 1.90 b | 1.91 a | 1.91 a | 1.90 b | 1.91 a | 1.91 a | 0.000 | *** |
| Mixes With | 14.0 | 14.0 | 14.0 | 14.0 | 14.0 | 14.0 | 14.0 | n/a | n/a |
| Saliva | | | | | | | | | |
| Chalky | 0.9 b | 0.9 ab | 0.9 ab | 0.9 b | 0.9 b | 0.9 ab | 1.0 a | 0.117 | *** |
| Mouthcoating | | | | | | | | | |
| Oily | 1.6 ab | 1.6 ab | 1.4 b | 1.6 ab | 1.7 ab | 1.7 ab | 1.8 a | 0.268 | ** |
| Mouthcoating | | | | | | | | | |

¹Means in the same row followed by the same letter are not significantly different at 95% Confidence.
***99% Confidence,
**95% Confidence,
*90% Confidence,
NS—Not Significant
The attributes at threshold or low are not bold.
The attributes above threshold are bold.
For other attributes, % score is the percentage of times the attribute was perceived, and the score is reported as an average value of the detectors

Sensory Acceptance of Agglomerated Coffee Creamers in Coffee with 100% Replacement.

To evaluate sensory parity of soy protein as a replacement for Sodium Caseinate, a consumer acceptability analysis of agglomerated non-dairy creamers based on different protein or combinations of protein having equal nutrient composition were analyzed. Specifically, the following products were tested: Sodium Caseinate, having 1.5% protein, 33% fat, and flavor added NDC; TL1-A, having 1.5% protein 33% fat, and flavor added NDC; SSP-A, having 1.5% protein, 33% fat, and flavor system 1 added NDC; SSP-A, having 2% protein, 33% fat, and flavor system 2 added NDC; 50:50 blend TL1-A:Caseinate, flavor added NDC; 50:50 blend SSP-A:Caseinate, flavor added NDC; and: 25:25:50 blend TL1-A:SSP-A:Caseinate, flavor added NDC.

The acceptance ratings were compared between non-dairy creamers prepared with Sodium caseinate and soy protein. Specifically, the products sampled included Sodium Caseinate, 1.5% protein, 33% fat flavor added NDC; TL1-A, 1.5% protein, 33% fat, flavor added NDC; SSP-A, 1.5% protein, 33% fat, flavor system 1 added NDC; and SSP-A, 1.5% protein 33% fat, flavor system 2 added NDC.

The samples were evaluated by 72 consumers willing to try coffee with creamer, prescreened as users of coffee whiteners. The Hedonic scale ranged from 1 being dislike extremely and 9 being like extremely and was used for Overall Liking, Flavor Liking, Aftertaste Liking, Color Liking, Mouthfeel Liking, and Appearance Liking.

Consumers evaluated samples prepared by adding 12 grams of each agglomerated spray dried coffee creamer to 180 mL of brewed coffee. The spray dried coffee creamer was blended until homogenized in the coffee. The samples were served by sequential monadic presentation.

The data was analyzed using the Analysis of Variance (ANOVA) to account for panelist and sample effects, with mean separations using Tukey's Significant Difference (HSD) Test.

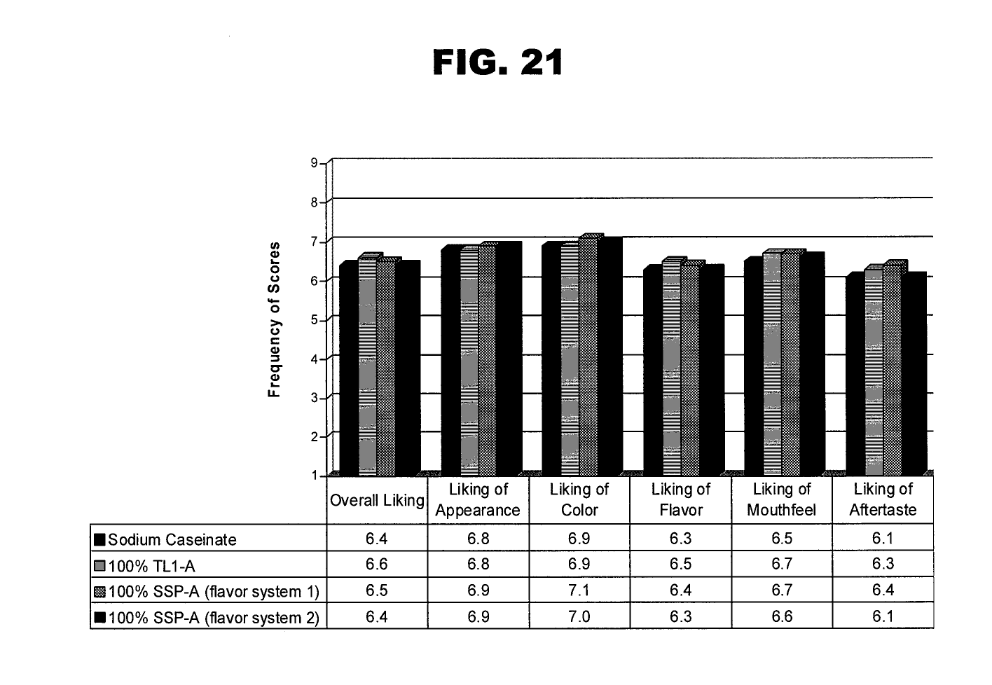

Complete replacement of Sodium Caseinate with TL1-A, SSP-A (flavor system 1), or SSP-A (flavor system 2) to achieve acceptability parity. In Overall Liking (FIG. 21), mean scores were not significantly different between Sodium Caseinate and TL1-A, SSP-A (flavor system 1), and SSP-A (flavor system 2).

In regards to Appearance Liking, Color Liking, Flavor Liking, Mouthfeel Liking, and Aftertaste Liking, there were no significant differences between Sodium Caseinate, TL1-A, SSP-A (flavor system 1), or SSP-A (flavor system 2) in Appearance Liking, Color Liking, Flavor Liking, Mouthfeel Liking, and Aftertaste Liking (FIG. 21).

### Acceptance of Agglomerated Coffee Creamers in Coffee (50/50 Blends)

The acceptance ratings were compared between non-dairy spray dried creamers prepared with Sodium Caseinate and soy protein. Specifically, the products sampled included Sodium Caseinate, 1.5% protein, 33% fat flavor added NDC; SSP-A, 1.5% protein, 33% fat, flavor added NDC; TL1-A, 1.5% protein 33% fat, flavor added NDC, and 25% SSP-A and 25% TL1-A, 1.5% protein 33% fat, flavor added NDC.

The samples were evaluated by 70 consumers willing to try coffee with creamer, prescreened as users of coffee whiteners. The judges used a 9-point Hedonic acceptance scale followed by a 5-point Diagnostic “Just About Right” scale. The Hedonic scale ranged from 1 being dislike extremely and 9 being like extremely and was used for Overall Liking, Appearance Liking, Color Liking, Flavor Liking, Mouthfeel Liking, and Aftertaste Liking.

Judges evaluated samples prepared by adding 12 grams of each agglomerated spray dried coffee creamer to 180 mL of brewed coffee. The spray dried coffee creamer was blended until homogenized in the coffee. The samples were served by sequential monadic presentation.

The data was analyzed using the Analysis of Variance (ANOVA) to account for panelist and sample effects, with mean separations using Tukey's Significant Difference (HSD) Test.

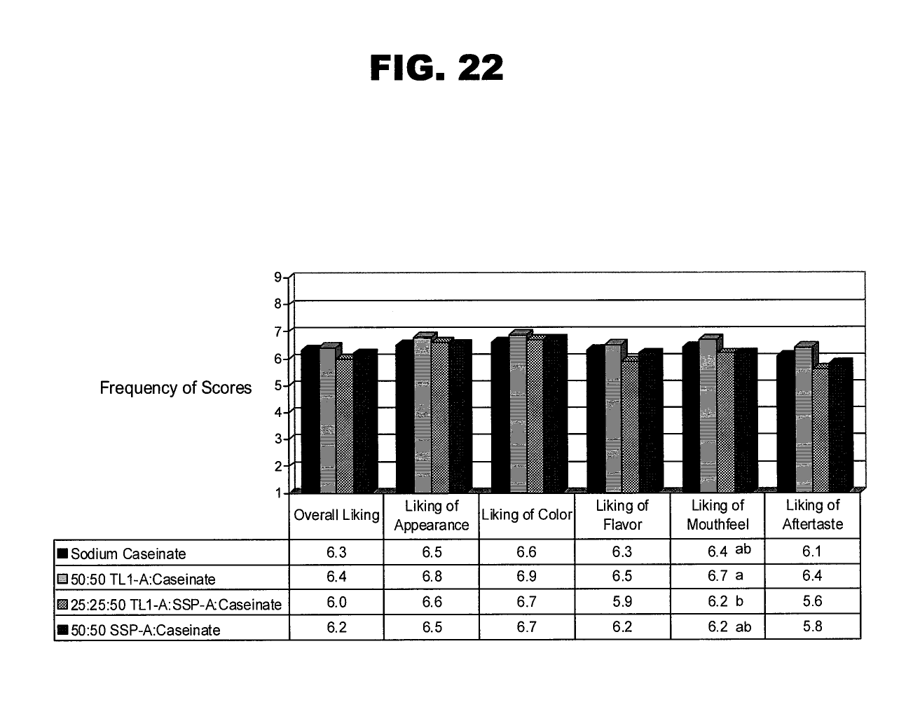

The use of 50% replacement of Sodium Caseinate with SSP-A, TL1-A, or either 25% TL1-A and 25% sC 8.7, to achieve parity acceptability. In Overall Liking, there were no significant differences between Sodium Caseinate and 50:50 TL1-A:Caseinate, 25:25:50 TL1-A:SSP-A:Caseinate, and 50:50 SSP-A:Caseinate (FIG. 22).

Also in Appearance Liking, Color Liking, Flavor Liking, and Mouthfeel Liking there were no significant differences between Sodium Caseinate and 50:50 TL1-A:Caseinate, 25:25:50 TL1-A:SSP-A:Caseinate, and 50:50 SSP-A:Caseinate in Appearance Liking, Color Liking, Flavor Liking, and Mouthfeel Liking (FIG. 22).

The mean scores for 50:50 TL1-A:Caseinate were significantly higher compared to 25:25:50 TL1-A:SSP-A:Caseinate in Aftertaste Liking (FIG. 22).

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A non-dairy creamer composition, the non-dairy creamer comprising:
(a) a protein hydrolysate composition comprising a mixture of protein and polypeptide fragments having a degree of hydrolysis of at least about 0.2%;
(b) a protein content of at least about 0.5%;
(c) a pH of at least about 7.0; and
(d) an edible material.

2. The non-dairy creamer of claim 1, wherein the protein hydrolysate composition is derived from a protein selected from the group consisting of soy, barley, canola, lupin, maize, oat, pea, potato, rice, wheat, animal, egg, and combinations thereof.

3. The non-dairy creamer of claim 1, wherein the protein hydrolysate composition is derived from soy in combination with at least one protein selected from the group consisting of barley, canola, lupin, maize, oat, pea, potato, rice, wheat, animal, dairy, and egg.

4. The non-dairy creamer of claim 1, wherein the soy protein is selected from the group consisting of soy protein, soy protein isolate, soy protein concentrate, soy protein extract, soy flour, powdered or dry soy milk, soy meal, ground soy bean, soy bean paste, and combinations thereof.

5. The non-dairy creamer of claim 1, wherein the protein hydrolysate composition is derived from soy, and the degree of hydrolysis is from about 0.2% to about 14%.

6. The non-dairy creamer of claim 1, wherein the non-dairy creamer composition has a moisture content of at least about 79%.

7. The non-dairy creamer of claim 1, wherein the edible material is selected from the group consisting of caseinate, soy protein concentrate, soy protein isolate, and combinations thereof.

8. The non-dairy creamer of claim 1, wherein the food product further comprises an ingredient selected from the group consisting of a sweetening agent, an emulsifying agent, a thickening agent, a stabilizer, a lipid material, a preservative, a flavoring agent, a coloring agent, and combinations thereof.

9. A method for producing a non-dairy creamer composition comprising the steps of:
(a) mixing and heating a protein hydrolysate composition comprising a mixture of protein and polypeptide fragments having a degree of hydrolysis of at least about 0.2% with at least one edible material to produce an aqueous slurry;
(b) homogenizing the slurry;
(c) pasteurizing the slurry; and
(d) cooling the non-dairy creamer composition to produce a liquid non-dairy creamer.

10. The method of claim 9, wherein at least one additional ingredient is mixed with the slurry prior to homogenizing the slurry.

11. The method of claim 10, wherein the additional ingredient is selected from the group consisting of a sweetening agent, an emulsifying agent, a thickening agent, a stabilizer, a lipid material, a preservative, a flavoring agent, a coloring agent, and combinations thereof.

12. The method of claim 9, wherein the liquid non-dairy creamer slurry is dried to form a dried non-dairy creamer.

13. The method of claim 9, wherein after step (c), the pasteurized slurry is spray dried to form a spray dried non-dairy creamer.
